(19) United States
(12) Patent Application Publication
(10) Pub. No.: US 2005/0170808 A1
(43) Pub. Date: Aug. 4, 2005

(54) Radio interoperability system

(76) Inventor: Gordon E. Hamilton, Princeton, TX (US)

Correspondence Address: MICHAEL A. O'NEIL, P.C., 5949 SHERRY LANE, SUITE 820, DALLAS, TX, 75225, US

(21) Appl. No.: 11/044,937

(22) Filed: Jan. 27, 2005

Related U.S. Application Data
(60) Provisional application No. 60/540,149, filed on Jan. 29, 2004.
(60) Provisional application No. 60/563,316, filed on Apr. 19, 2004.

(51) Int. Cl. H04M 11/04

(52) U.S. Cl. 455/404.1; 455/403

(57) ABSTRACT

Various governmental agencies each utilize one of four currently available radio frequency bands to facilitate intra-agency communications. Each of the radio frequency bands includes a mutual-aid channel. In the practice of the present invention whenever a state of emergency involving a particular agency is determined, the agency is directed to tune its radio communication system to the mutual-aid channel within the radio frequency band utilized by the agency. The mutual-aid channels of all of the radio frequency bands are interconnected during the state of emergency thereby facilitating communication among all of the agencies that are affected by the emergency.

### CLAIM OF PRIORITY

Applicant claims priority based on provisional patent application Ser. No. 60/540,149, filed Jan. 29, 2004 and provisional patent application Ser. No. 60/563,316, filed Apr. 19, 2004.

### TECHNICAL FIELD

This invention relates generally to radio communication systems, and more particularly to a system for facilitating emergency and other priority communications between governmental agencies at all levels.

### BACKGROUND AND SUMMARY OF THE INVENTION

A. The Problem.

Radio interoperability is a relatively new phrase that describes the perceived simple process of two or more people communicating with each other over wireless devices, typically two-way radios. In earlier times when all two-way radios utilized the same modulation standard (FM or frequency modulation, today often referred to as the conventional mode), persons needing to communicate with one another could do so by simply using the same frequency. With the introduction of multiple frequency bands allocated to police and public safety entities as a method of providing more radio space or channels to handle increasing traffic levels, the simple interoperability which facilitated conversations among different agencies began to suffer. Radios that operated in the VHF-band could not be tuned to the frequencies (or channels) of radios in the UHF-band, and radios in the Low-band could not be tuned to frequencies in the other bands. This problem has expanded as more radio frequency bands have been allocated and different access methods have been deployed for intra-agency radio communications. The use of different digital modulation methods and different modalities for computer assignment of channels by various equipment manufacturers has further frustrated efforts at interoperability. In addition to the varying digital modulation methods employed by different equipment manufacturers, each computer assignment system is held proprietary by the equipment manufacturer so others cannot provide equipment operable on the system.

Because our perception of community has expanded our relevant geographic areas and interactions with other entities to very large scales, it is increasingly crucial that:
City fire departments must be able to communicate with the rural fire departments in instances of mutual-aid assistance.
City police departments must be able to communicate with county sheriff departments and state police entities when dealing with incidents of multi-jurisdictional responsibility.
Any of the foregoing as well as other emergency and rescue services must be able to solicit assistance and communicate directly with medical and ambulance services for support in life and death situations.

This need/requirement extends to all entities within the immediate area and can easily escalate to a state-wide, regional, or national scale when consideration is given to recent events such as the shuttle disaster, recurring tornadoes and hurricanes, forest fires, etc.

A “local” scenario that could easily require multi-agency communications is a collision involving a truck loaded with hazardous materials at an urban exit from an interstate highway.
The local police would be involved;
The local fire department may be involved;
Medical services may be involved;
The water department may have to shut off the water;
The local public works department may be needed to cut up and haul off the trees that were downed and are blocking traffic;
State troopers may investigate the accident scene;
The sheriff's department may re-direct traffic on the interstate; and
The hazardous-material team begins work to clean up the materials that spilled on the road.

It could take hours for an event commander to coordinate all these activities through different department dispatchers. However, with radio interoperability, one call to each dispatcher would alert required personnel to switch to the mutual-aid interoperability channel, whereby all designated personnel could participate in necessary communications. Therefore, radio interoperability provides improved disaster control, quicker response times, improved safety, and better clean-up with less effort and time.

Examples of major events involving poor communication among participating agencies include:
Branch Davidian episode
Oklahoma City bombing
Hurricanes
Floods
Tornadoes
New York City, Washington, D.C. and rural Pennsylvania on Sep. 11, 2001
Space shuttle disaster
Forest fires in Texas, Colorado, New Mexico and California
Power outages in the Northeast and elsewhere
Snipers in the greater Washington, D.C. area, etc.

One common thread in all these instances is that they were multi-agency and multi-jurisdictional response events in which concise, real-time communication was a requirement but was mostly non-existent. While each agency may have been able to communicate within itself, usable inter-agency communication failed or was non-existent during these and other major events and emergency responses.

The frequency resources that must be included in radio interoperability are:
Low band—25 MHz through 50 MHz
VHF band—150 MHz through 174 MHz
UHF band—406 MHz through 420 MHz
UHF band—450 MHz through 470 MHz
800 MHz band—806 MHz through 869 MHz
900 MHz band—901 MHz through 936 MHz
700 MHz band—(proposed).

Existing systems in various areas operate on some or all of the above-listed radio frequency bands.

B. Existing Proposals for Solving the Problem.

1. Utilize Publicly Offered Services:

Although on the surface this option may appear attractive, the hidden cost of this type of offering would be the replacement cost of all existing mobile and portable equipment as well as the monthly service fees to operate the service. Existing publicly available services tend to have good, dense coverage capabilities within the metropolitan areas and along major highways but are lacking in the rural areas. The systems are designed to handle day-to-day large service demands but because they are based on the public telephone network they are not designed to operate during major events such as the 9-11-01 disaster. This limitation is due to the financial design criteria in the public network itself for redundancy, alternate paths, and severe call rates from a given area. Also, because demands on the public telephone network reach extremes during major events, public systems are apt to fail because of competition for the required resources of the public backbone network that carries the system traffic. Also, public systems typically do not provide adequate service in rural areas in emergency situations, such as the NASA shuttle disaster in East Texas.

2. Connect Existing Systems:

Since there are many different and discrete local systems already in operation, one option would be to simply connect all of these systems together through simple devices located at dispatch centers thereby allowing agencies to communicate with each other. Referring to FIG. 1, the problem with this concept is that the actual radio coverage of any one system does not cover much geographic area. This option would allow users in one city to communicate with users in another city but would not allow the users from city A to come into city B to assist with an event because users from city A would not have their required radio system coverage when they left their home city. Options to expand the coverage of all the systems to provide coverage to all other areas would be cost-prohibitive even at a regional (Council of Governments) level. Also, this scenario does not address system usage by all of the state and federal agencies which also has a very high probability of needing to communicate within the area, nor does it address the proprietary nature of each manufacturer's system where one brand cannot communicate with other brands. To accomplish that task, multiple layers of equipment would have to be installed at a cost that would be prohibitive.

3. Develop New Technologies for a New System:

Referring to FIG. 2, this concept involves scrapping all presently utilized communication systems in favor of an entirely new system which is capable of communicating within a local area, between and among adjacent areas, between and among agencies at all levels, throughout a state or region, and even nationally.

Although this is the most desirable plan in the long term, it is the most expensive option. The estimated cost for such a system to cover just the state of Texas is $2.25 billion with a projected development schedule of 5 years and a deployment schedule and funding cycle of around 8 years. This option would bring no relief and/or services for approximately 12 to 15 years.

4. The Present Invention Solves the Problem.

Utilizing Existing Infrastructure and Enhancing Interoperability Functionality:

The present invention utilizes existing publicly owned and operated VHF infrastructure and adds facilities to provide radio frequency support for all radio bands along with integration of a method to connect these radio bands together for radio interoperability. The plan provides a method for all governmental agencies to directly communicate with each other. Regional and local entities also access the system to communicate with the state and national agencies as well as among themselves.

Since the least common denominator of all of the radio communications systems in a given area is the FM (frequency modulated or conventional system) method, the system employs an FM operating method thereby allowing ALL existing base station infrastructure along with ALL existing mobile and portable transmitting equipment to be kept and utilized. No agency would need to purchase any new or different mobile equipment. For example, the existing 460 or so VHF stations owned and operated by the state of Texas for their agency communications would be utilized, and additional radio base stations would be placed at the existing sites to allow for the cross connections of the different radio bands.

Referring to FIG. 3 the existing VHF stations would be retained while UHF and 800 MHz stations would be added along with an interoperability base station controller (also sometimes referred to herein as an interoperability radio controller) to allow for the cross connections that are necessary for interoperability purposes. The entire state of Texas, for example, could be covered for all VHF, UHF, and 800 MHz services for approximately $28 million and could be completed within one year. This scenario DOES address system usage by all federal, state, and local agencies involved major events requiring complex communications.

The system comprising the present invention can easily support both the horizontal requirements for mutual-aid within a given area, such as police, fire, ambulance, medical, and other public services, as well as providing connections to public utilities (gas, electricity, water, telephone, etc.), public transportation services, and suppliers that may be needed for assistance during any event. The design also supports and promotes the vertical escalation that usually becomes necessary at regional, state, and federal levels, depending on the event and severity of the emergency. Such disasters may include the Coast Guard and other maritime entities along coastal areas, the Border Patrol along international borders, or other state, regional, and local entities where events may affect areas with other states and regions.

The invention also provides a standard method of interoperability among all agencies and can be installed utilizing the existing and defined mutual-aid frequencies that have been allocated by the FCC for these basic purposes in all of the required radio frequency bands. Thus, the system of the present invention easily supports the interface with other state agencies and entities. By utilizing pre-selected frequencies, the system of the present invention can provide RF coverage with overlapping services to support multiple events in a given area and support many events simultaneously within the region. Referring to FIG. 4, the present invention can be implemented simply by deploying a frequency re-use plan based on the frequencies that are standard for mutual-aid services.

By utilizing FCC-allocated frequencies, the present invention also facilitates requesting assistance from agencies all across the country, and the personnel that are sent are able to use their existing radios to communicate with all agencies while deployed.

### BRIEF DESCRIPTION OF THE DRAWINGS

A more complete understanding of the present invention may be had by reference to the following Detailed Description when taken in connection with the accompanying Drawings, wherein:

FIG. 1 is a diagrammatic illustration of the concept of connecting existing systems in an attempt to achieve interoperability;

FIG. 2 is a diagrammatic illustration of the concept of designing new technologies to achieve interoperability;

FIG. 3 is a diagrammatic illustration of the radio interoperability system of the present invention;

FIG. 4 is a diagrammatic illustration further illustrating the radio interoperability system of the present invention;

FIG. 5 is a diagrammatic illustration of the use of the present invention to achieve radio interoperability among radio communication systems operating on a variety of frequency bands;

FIG. 6 is a schematic illustration of an interoperability radio controller of the present invention;

FIGS. 7a through 7k, inclusive, comprise a detailed circuit diagram of a first preferred embodiment of the system of the present invention; and

FIGS. 8a through 8q, inclusive, comprise a detailed circuit diagram of a second preferred embodiment of the system of the present invention.

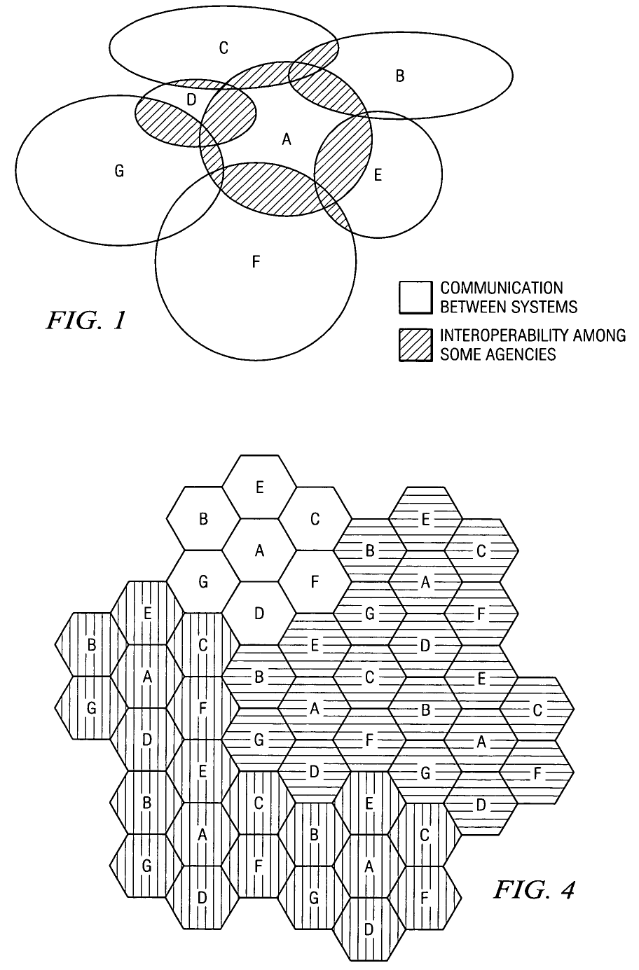

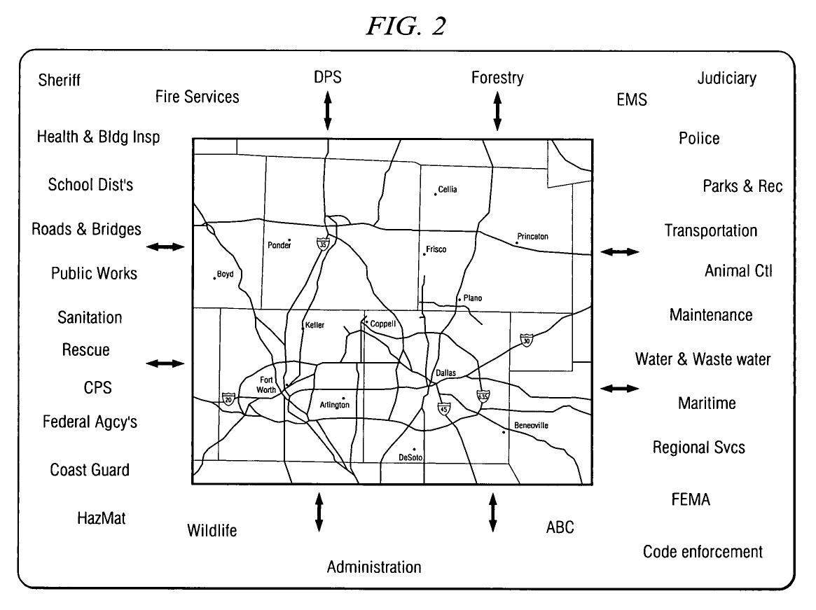

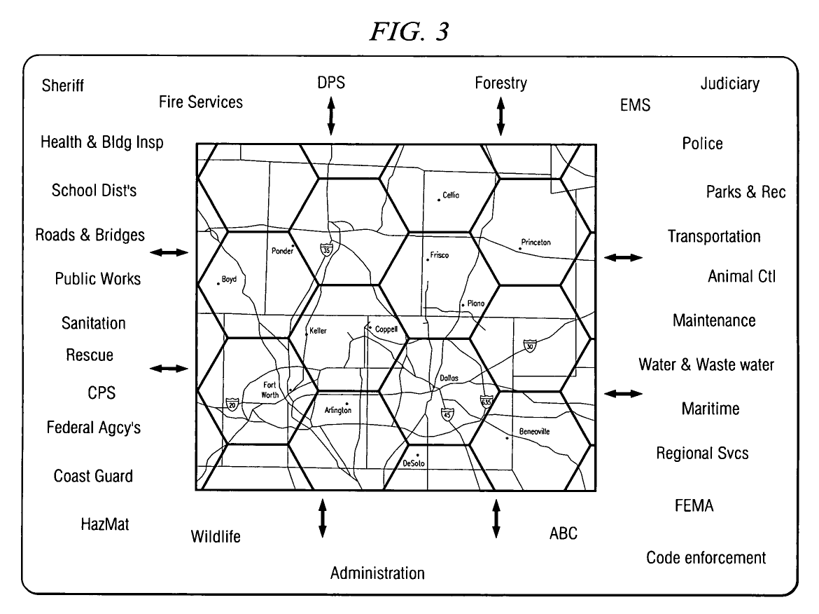

### DETAILED DESCRIPTION

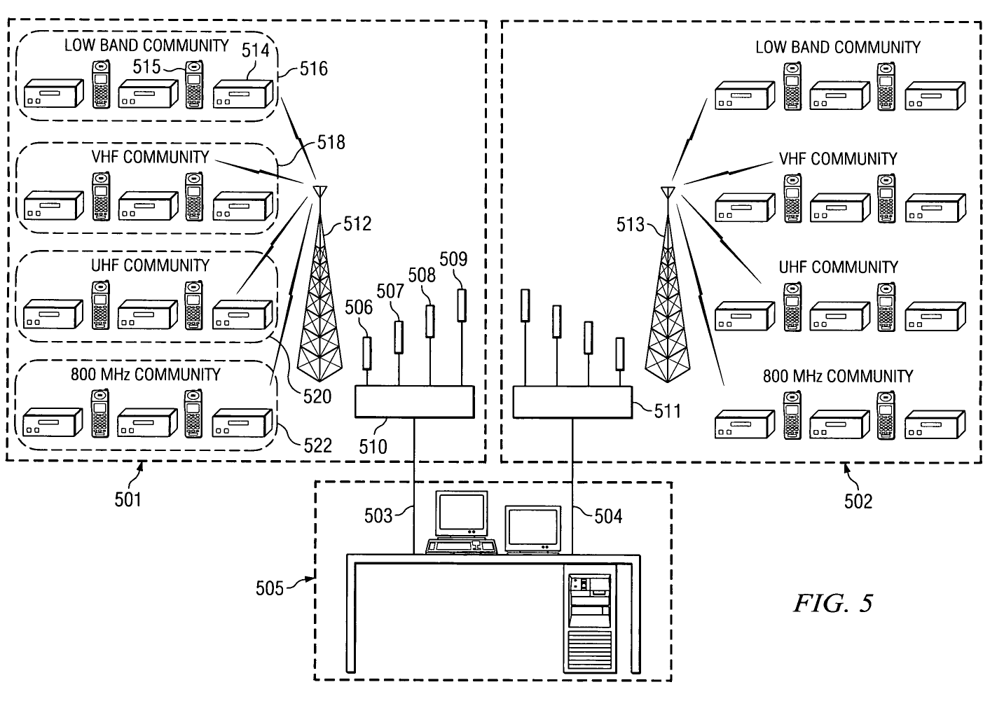

Referring to FIGS. 5, 6, 7a-7k, and 8a-8q, the radio interoperability system of the present invention is a flexible multi-port audio routing switch combined with a radio base station controller designed to provide versatile and flexible radio interoperability among public service and public safety entities during emergency events. The design of the system enables it to be placed at sites and configured and interfaced with existing and/or additional radio communications infrastructures. The system then senses radio signals, interpolates signals, and provides control of base station equipment along with routing the desired radio communications between users on different systems and radio bands (VHF-low band, VHF-high band, UHF-all bands, 800 MHz, and 900 MHz—all bands along with telephone line connections to central dispatch locations, and including other frequency bands that may be assigned) all to a common communications path irrespective of operating frequencies. The device is located at the base station sites thus alleviating the requirements of expensive multi-link control circuits specifically intended for interoperability. The system is interfaced to the dispatch location by a single audio circuit for both remote control and operation and typically utilizes existing control lines. The configurations supported by the system operate with and provide control for the direct interface of simplex, half-duplex, and full-duplex frequency operations and provide for both cross-band and same band repeating.

The system control logic allows the installer to select port priority levels (as defined in the system set-up), allows selected systems to interlock other systems, and in all cases allows the dispatch location to over-ride any and all communications to establish emergency operations disciplines as may be necessary from time to time in order to establish and/or maintain orderly communications in emergency situations. The repeat function/mobile-to-mobile interoperability function is disabled in normal operations, but allows mobile-to-dispatch communications. The repeat function/mobile-to-mobile interoperability function is then enabled by the dispatcher as requests for such interoperable communications are received. Enabling the repeat function is as simple as dialing a 4-digit touch-tone sequence or using other signaling methods that may already be in place. Radio base stations comprising the system may also be equipped with multiple operating frequencies to allow maximum benefit of the existing mutual-aid facilities, frequencies, capacity requirements, etc., and are simply selected by the dispatch operator with 4-digit touch-tone dialing sequences. Each control function activated by the dispatch operator is positively acknowledged by the system of the present invention to provide status of the requests. In cases where events cover very large areas that may require the radio coverage of multiple sites, the sites can be bridged using standard bridge/patch facilities as well as being bridged into other systems. Since the function of the system is that of an audio routing device and radio base station controller, it is mode/protocol-transparent to the network.

The system of the present invention functions with existing communications equipment (base stations, mobiles, and portables) and can also be configured to operate in a mobile command vehicle as a “portable” interoperability communications facility.

Features and benefits incorporated in the system of the present invention include:
All existing mobile and portable equipment can interoperate
Command override provides ability of event commander to take control over all other transmissions
First receiver active locks out all others during transmission alleviating interference between systems
Support for both horizontal and vertical mutual-aid requirements and event escalation
Radio protocol insensitivity
Equipment brand insensitive
Multiple radio bands and multiple radio channels connected on demand
Direct communications between diverse radio technologies, systems, and brands
Supports small single-site and very large multiple-site demands
Instant communications: No processing and routing delays resulting in real time full analog voice communications
Disable function does not eliminate sites from service
Site dimensioning on an as-needed/required basis
The most cost-effective and broad based solution available
Very small size and space requirements
DC power requirements to allow for mobility operations
Very low dc power requirements

### EXAMPLE

To facilitate interaction, support, and coordination of multi-jurisdictional disaster and emergency events, agencies use a Memorandum of Understanding which is a pre-defined outline and agreement to work jointly on such events and a definition of typical procedures and operating methodologies to be utilized in such events.

A typical report of such an event normally comprises a 911 call to a dispatch center by someone reporting the event (fire, wreck, shooting, disturbance, etc.). The 911 operator/dispatcher screens/defines the call and then issues instructions to the responsible public safety agency. That agency assigns (through a central dispatch facility) the necessary initial resources to respond to the call. Upon arrival at the event location the first responders evaluate the situation and severity against their capabilities and needs. If no additional support or assistance is required, the event commander on site will work the situation on site. If it is determined that additional support, either from like resources or different resources, is necessary, a call is placed to additional entities for assistance. Upon assignment the additional entities are assigned communications resources to utilize for operations comprising the mutual-aid event and a dispatch facility is assigned to monitor and assist throughout the event. A watch captain located at the dispatch center is normally designated as the Event Commander and will coordinate and monitor all activities of the assigned resources and respond with additional facilities and resources as may be deemed necessary.

Assume that a fuel tanker transport vehicle headed north on route US75 just outside the city limits of McKinney, Tex. has lost control, crossed the center medium and crashed with other oncoming traffic; the truck and fuel have ignited; and the accident is located directly under an overpass across the US75 highway.

A 911 call from a passing motorist reports a wreck involving an 18-wheeler and other vehicles, and that there is something major on fire. The 911 dispatcher contacts the Weston, Tex. Fire Department and the Collin County Sheriff's office for assignment. After reaching the situation and evaluating the event on site, the responding personnel call the dispatcher for additional assistance from the McKinney Fire Department, State Police, ambulance, and wrecker services. Since all of these entities operate discrete, different, and incompatible radio communications systems, the dispatcher assigns all of the entities to a mutual-aid facility so that coordination among all responders can be optimized and monitored by the Event Commander.

By means of the preferred embodiments of the present invention, all of the agencies involved are able to directly communicate and monitor all activities regarding the situation. The result is the saving of precious minutes relative to the health and safety of involved victims, and additional people driving upon this situation. Traffic can be stopped or diverted away from the location, the overpass closed and blocked, the rescue/evacuation of victims accomplished, on site emergency medical stabilization and evaluations performed, and medical transport started. With direct communications among all personnel involved, all aspects of human communications can be imparted to all other participants.

Thus, as described above, government services such as police and fire departments within a local community communicate using mobile and portable radio transceivers that may operate on an assigned frequency band, use a particular modulation scheme, and employ a particular coding technique. This results in the inability of different government services to intercommunicate, for example, among services operating in different cities or counties, or services operating in different administrations. The interoperability radio controller of the present invention provides means to enable such intercommunity communication by coupling the interoperability radio controller to a plurality of local radio transceivers. Each local radio transceiver accordingly serves a particular radio community by operating on a selected frequency band, using a particular modulation scheme, and employing a particular coding technique. The local radio transceivers are coupled to the interoperability radio controller using a plurality of local radio ports in the controller. The ports are configured with a priority structure for communication with the local radio transceivers that is controlled by a dispatcher.

FIG. 5 illustrates two exemplary radio interoperability systems, 501 and 502, coupled by four-wire telephony channels, 503 and 504 to a common remote dispatching facility, 505. Each radio interoperability system 501, 502 can operates as a stand-alone system that provides interoperability amongst a plurality of different radio “communities” (also referred to herein as user communities) which communities otherwise could not intercommunicate due to different broadcast frequency bands, modulation schemes, coding schemes, or other incompatibilities. Each radio interoperability system includes a plurality of local radio transceivers, for example 506, 507, 508, and 509 in radio interoperability system 501. Each local radio transceiver operates on a particular government radio service such as, without limitation, a low-band high-frequency service, a VHF service, a UHF service, or a 800 MHz service, uses a particular modulation scheme, and employs, if necessary, a particular coding technique to communicate with a served radio community. In one example, local radio transceiver 506 might support and communicate with a first radio community 516 that operates on the low frequency band. Radio community 516 could include all of the mobile radios for e.g., a local police department. Local radio transceiver 507 might support radio community 518, which includes all of the mobile radios by which e.g., the local fire department communicates, using the VHF frequency band. Likewise, local radio transceiver 508 might support and communicate with radio community 520, operating in the UHF frequency band, and local radio transceiver 509 might support radio community 522, which operates in the 800 MHz frequency band.

The local radio transceivers such as 506, 507, 508, and 509 are each coupled to one of the two interoperability radio controllers, 510, 511 as illustrated in the exemplary arrangement shown on FIG. 5. The radio interoperability systems 510 and 511 can also be configured as mobile controllers, meaning that either or both of the controllers could be configured to be a mobile device, such as might be employed in a disaster recovery or emergency response vehicle. Each interoperability radio controller provides cross-community communication utilizing mutual-aid channels in the selected frequency bands served by the radio transceiver groups. One skilled in the art will recognize that each radio community (e.g., 516, 518, 520, 522) has a mutual assistance channel, which is a particular channel frequency that has been reserved as a matter of protocol for certain communications. As will be explained in further detail below, in the preferred embodiments of the present invention, each of transceivers 506, 507, 508, and 509 monitors for communications on the mutual assistance channel and, when received, communicates those communications to a another (one or more) radio community (using the other radio community's frequency, modulation, coding protocols), as dictated by the dispatcher facility 505. To provide wide geographical area coverage, antennas for the local radio transceivers, 506, 507, 508, 509 are generally located at elevated positions on towers, 512 and 513. Government operators in a user community typically use mobile radio transceivers, 514, that may be mounted in a vehicle such as a fire truck or an ambulance, or portable radio transceivers, 515, that can be hand carried, any of which can be dispersed over a wide geographical area.

The dispatching facility, 505, that need not be located at either tower, controls communication among the individual local radio transceivers as described hereinbelow. Remote location of the dispatching facility is enabled, for example, by the four-wire telephony channels, 503 and 504 or by radio links. The dispatching facility can also be configured as a mobile facility employing a radio link. The dispatching facility can bridge traffic from one radio interoperability system, e.g., 501 to the other, e.g., 502, for example by using patch cords (not shown), thereby enabling a wide level of interservice communication for an event that may span multiple geographical and administrative areas.

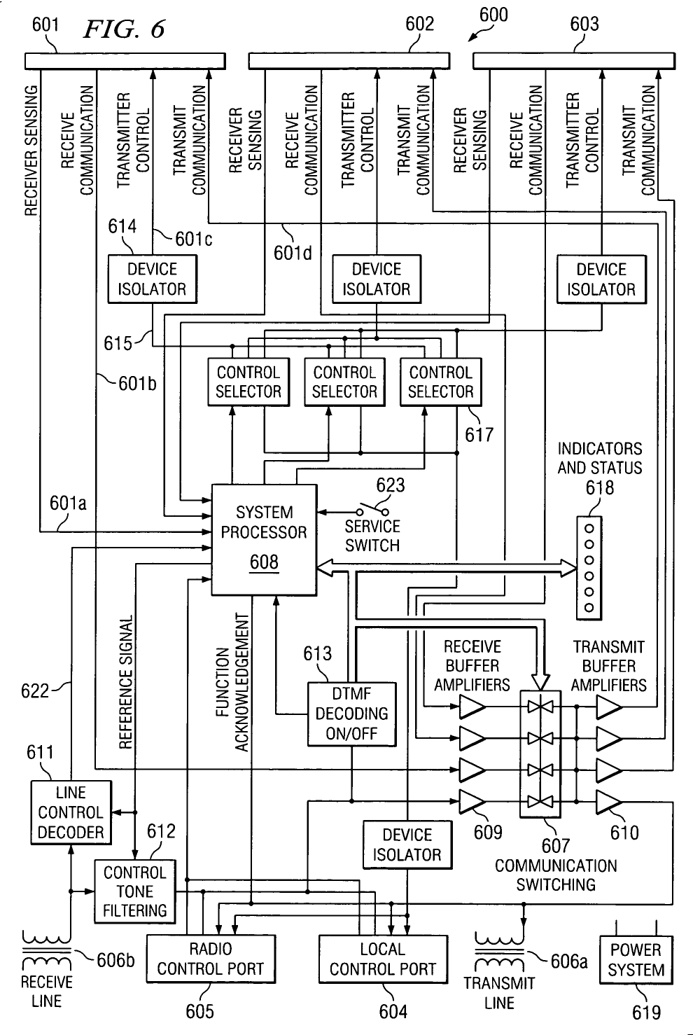

Referring next to FIG. 6, illustrated is an exemplary block diagram of an interoperability radio controller 600. Interoperability radio controller 600 corresponds to either of 510 or 511 in FIG. 5, for instance. Interoperability radio controller 600 includes three local radio ports 601, 602, and 603 that are configured to communicate and interface with three local radio transceivers (such as local radio transceivers 506, 507, and 508 of FIG. 5) to provide interoperability. Although FIG. 6 illustrates three local radio ports, a larger or smaller number is well within the broad scope of the present invention. The three local radio transceivers each provide communication over a mutual-aid channel with a selected government radio service. Such separate government services normally communicate within a community over radio arrangements procured commercially from different vendors that are generally not interoperable because they operate on different frequencies or employ different modulation or coding schemes as described above. A plurality of radio transceivers operating even on only one frequency band may thus not be interoperable with transceivers in a different government service. The interoperability radio controller 600 provides means for interoperable communications among these services.

Interoperability radio controller 600 controls communications among the different radio communities (516, 518, etc.) under the control of a dispatcher such as dispatcher 505 of FIG. 5. System level control for such interoperable communication is selectively provided by either the local control port 604 or the radio control port 605, or both. Local control port 604 provides communication and system control for an on-site technician that may be performing maintenance activities (or in some instances an on-site dispatcher). Radio control port 605 provides communication and system control for a remotely located dispatcher who, for example, may be at a police station, who communicates over a radio link and who is responsible for system operation. Additional communication and system control is also provided for a remotely located dispatcher by means of a four-wire telephony circuit that may be implemented with an ordinary telephone channel and that may be carried by a microwave or fiber link or other telecommunication means coupled to transmit line 606a and receive line 606b. A two-wire telephone circuit for such communication is also included in the broad scope of the present invention. The interoperability radio ports 601, 602, and 603 can be configured to transmit and receive half-duplex or full-duplex signals from and to a dispatcher using transmit and receive lines 606a and 606b. This enables orderly communication of audio signals between radio devices utilized in separate government radio services. In addition, interoperability radio ports 601, 602, and 603 can be configured under dispatcher control to transmit or receive audio signals to all (or to selected ones of, as selected by the dispatcher) government service receivers tuned to receive such signals on each receiver's respective mutual-aid channel.

A system processor 608 provides overall control of the interoperability radio controller 600. The system processor 608 in a preferred embodiment is implemented with a microprocessor, but a controller implemented with discrete or other integrated circuit elements is well within the broad scope of the present invention. The system processor receives control signals from the dispatcher-controlled ports 604, 605, and/or 606a and 606b, and/or from the interoperability radio ports such as 601. The processor 608 can disable or reenable the radio interoperability system as signaled by a technician operating the service switch 623.

When an operator using a remote radio device broadcasts on a mutual-aid channel of a government radio service (i.e., a radio community) monitored by the interoperability radio controller, a local radio transceiver, such as transceiver 506 (FIG. 5) receives and demodulates the transmitted signal and passes the audio signal through an appropriate interoperability radio port, such as port 601 of FIG. 6. Voltages on receiver sensing leads such as 601a are continually monitored by the system processor 608, which detects a voltage on lead 601a when it exceeds a threshold level. The signal on lead 601a may be implemented using a squelch-type circuit or other circuit arrangement as is well understood in the art. In a preferred embodiment, the threshold level is set in software executed by the microprocessor in the system processor, but other threshold detection means such as an analog circuit including a comparator with a dc voltage level applied to one input terminal is an alternative circuit arrangement within the broad scope of the present invention. The received audio signal from the operator (e.g., a user broadcasting on a mobile radio 514 or handheld radio 515 of radio community 516) is provided on lead 601b, and can be selectively retransmitted (under the selection of a dispatcher) to other operators using other government radio services (e.g., users of community 518, 520, and/or 522). An audio signal to be transmitted on a return communication path to the original operator is provided on lead 601d. Control of the transmitter (e.g., the local radio transceiver 506) to transmit the return signal is provided by the system processor on lead 601c. Communication in this manner is enabled on a first-come, first-served basis, thereby preventing “talk-over” signals from interfering with each other. Signals with later origination times that would otherwise be interfering signals are blocked by the system processor 608 until the first-served communication is completed. In other words, assume that the dispatcher has configured the interoperability radio controller 600 so that messages coming in on any of the ports (e.g., 601) is re-transmitted to the other ports (in this case 602 and 603). Assume further that a first audio signal is received on port 601 and that a second audio signal is received on port 602 a short time later. System processor 608 will prevent re-transmitting the signal received on port 602 (which will be re-transmitted on ports 601 and 603) until after the signal received on port 601 has been re-transmitted on ports 602 and 603. One skilled in the art will recognize that many additional advantageous features can be realized through the interactive and real-time control over controller 600 by a local or remotely located dispatcher. Signals similar to those provided in the interoperability radio ports such as 601 are provided in the local control port 604 and in the radio control port 605. However, the signals in ports 604, 605, and 606a and 606b that are used by a dispatcher are necessarily treated by the system processor with higher priority than the signals in ports 601, 602, and 603, and always override communication in ports 601, 602, and 603. A further prioritization can be established among dispatcher-operated ports 604, 605, and 606a and 606b. Likewise, if desired, a prioritization protocol could be established amongst the various radio communities. As an example, assume that radio community 516 (e.g. a state police department) has been tasked with the responsibility of coordinating the efforts of other communities 518, 520 (e.g., a local police department and a city fire department). Under these circumstances, a dispatcher at station 505 may signal system processor 608 to over-ride the typical first-come, first-served protocol for handling incoming signals and instead provide that signals received from community 516 (e.g., via port 601) will be allowed to interrupt signals received from other communities (via the other ports 602, 603).

Cross-connecting linkages between interoperability radio ports such as 601, 602, 603 are provided by the communication switching block 607. Communication switching block 607 couples any one of the interoperability radio ports 601, 602, and 603 or the operative dispatcher-controlled ports, 604, 605, or 606a and 606b, to selected ones or all of the other ports. In this manner, means are provided so that the dispatcher can enable a signal received on one port, such as 601, to be transmitted on any or all of the mutual-aid channels associated with the other ports, such as ports 602 and 603. In addition, the dispatcher can interrupt or disable any or all communication ports, or can broadcast communication over any or all ports in a one-way communication mode. Audio signals to all ports such as the interoperability radio ports or the control ports are coupled to the communication switching block 607 and are buffered before and after the communication switching block to maintain signal integrity by receive and transmit buffers such as 609 and 610, respectively.

The dispatcher controls the system processor in a preferred embodiment by means of a single-frequency signaling tone, preferably within the audio band, that may be selectively superimposed on the audio signal such as by a push-button arrangement (“push to talk”) in the receive line 606b. When such a tone is present, it is detected by the line control decoder 611 that is configured with a narrow bandpass filter tuned to the single-frequency tone. An indication of the presence of such a tone is coupled to the system processor over line 622 which responds by enabling transmission from the dispatcher. To prevent such single-frequency tones from interfering with normal speech communication, control tone filtering block 612 includes a notch filter tuned to substantially attenuate such single-frequency signals from the communication path, thereby restoring intelligibility for normal speech.

Further control signals can be sent to the system processor in the form of dual-tone multi-frequency (DTMF) signals that are normally generated by a Touch-Tone® telephone keypad. These signals are detected by the DTMF decoding block 613, that sends signals to the system processor over a plurality of lines that indicate the presence of each tone detected in a DTMF signal. Particular DTMF sequences can be used to enable or disable particular interoperability radio ports, collectively or in combinations. In a simple system arrangement, a single DTMF sequence may be used to enable or disable all interoperability radio ports. In yet other embodiments, the dispatcher may program or control system processor 608 via a wireline (e.g., Ethernet) or wireless network interface card (NIC) (not shown) coupled to an appropriate communications network such as a local area network or wide area network, the Internet, or the like). High level commands (or low level commands) could be sent over the network and NIC to be interpreted and acted upon by the system processor.

The transmit function of the radio transceivers (e.g., 506) that are coupled to the local communication ports such as 601 is controlled by a line such as 601c. Due to the multiplicity of possible control, powering, and grounding arrangements in various commercial radio transceivers, an isolated contact closure is provided to control the transmit function in the local interoperability ports and the local control ports in the interoperability radio controller 600. Accordingly, device isolators such as 614 are provided that can be configured in a preferred embodiment using relays, wherein the relay coil is energized over lines such as 615. In a further preferred embodiment, the relays are configured with reed relays. An isolated contact closure is provided to a port over a line such as line 601c. Current to the relay coils is selectively enabled by control selectors such as 617 that are controlled by the system processor 608.

Status of the system is displayed by the indicator and status panel 618 that may be configured with light emitting diodes (LEDs). Individual LEDs can indicate the presence of a received or transmitted signal over a port, whether power is turned on for the system, and whether the system is enabled or disabled.

Power for the system is provided by power supply 619. The power supply typically supplies a well-regulated source such as a 5-volt or 3.3-volt source for the microprocessor and any other voltage levels required by specific system components. The power supply may include back-up power means such as a battery to provide continuous system operation in the event of a power mains failure.

Thus, the block diagram of the interoperability radio controller 600 illustrates a system arrangement capable of enabling bidirectional communication between disparate government radio services with priority overrides, broadcast capability, and dispatcher control. An operator or the dispatcher on one channel can be multi-cast on many channels, and individual channels can be selectively disabled.

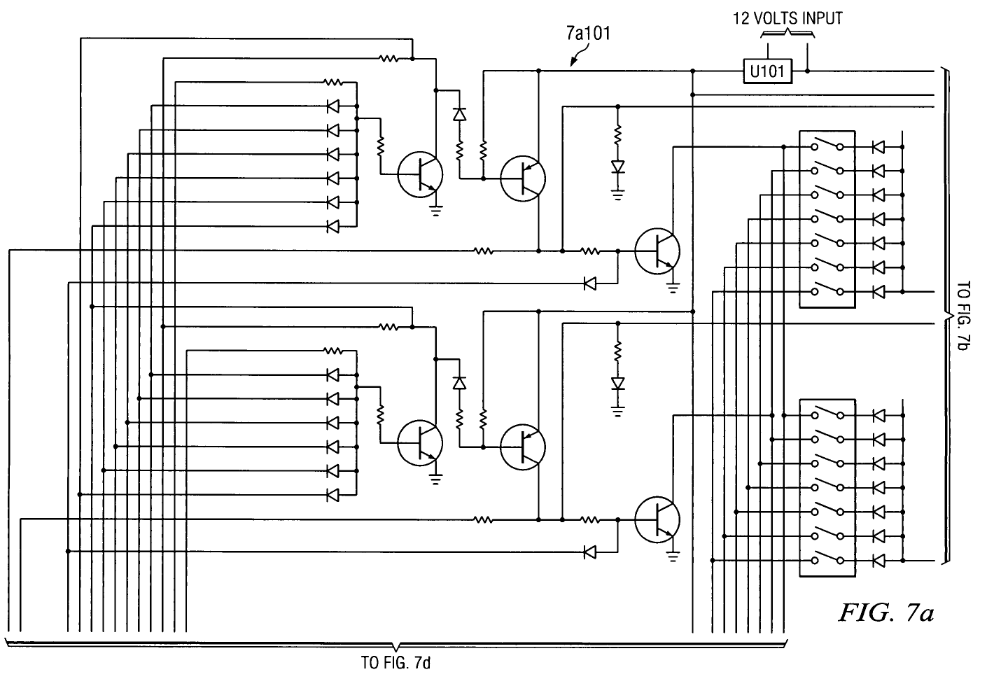

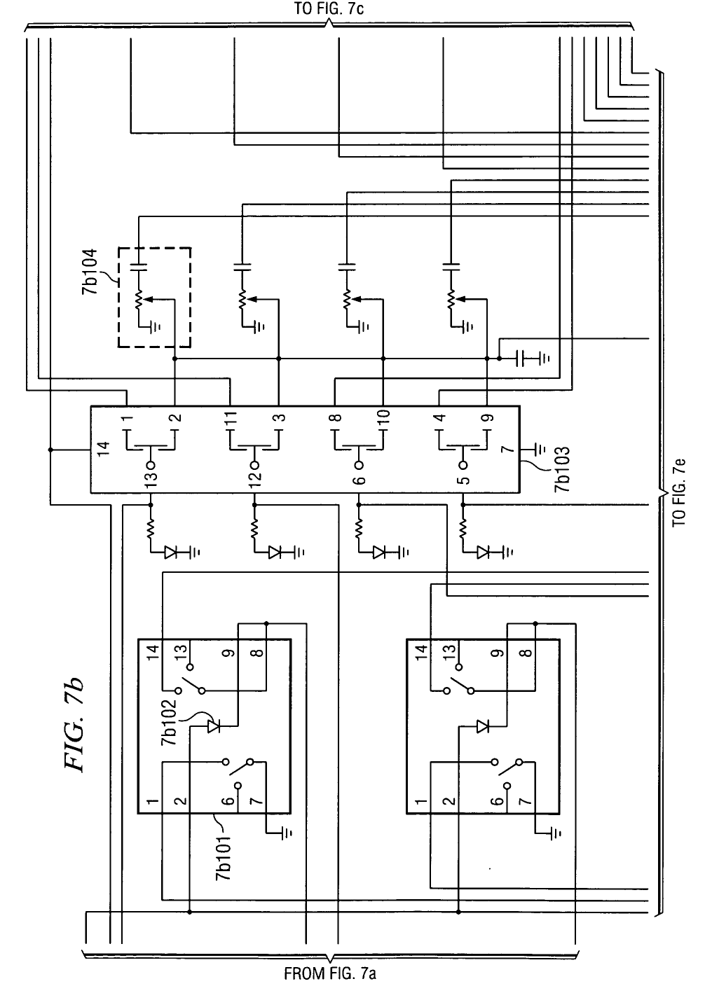

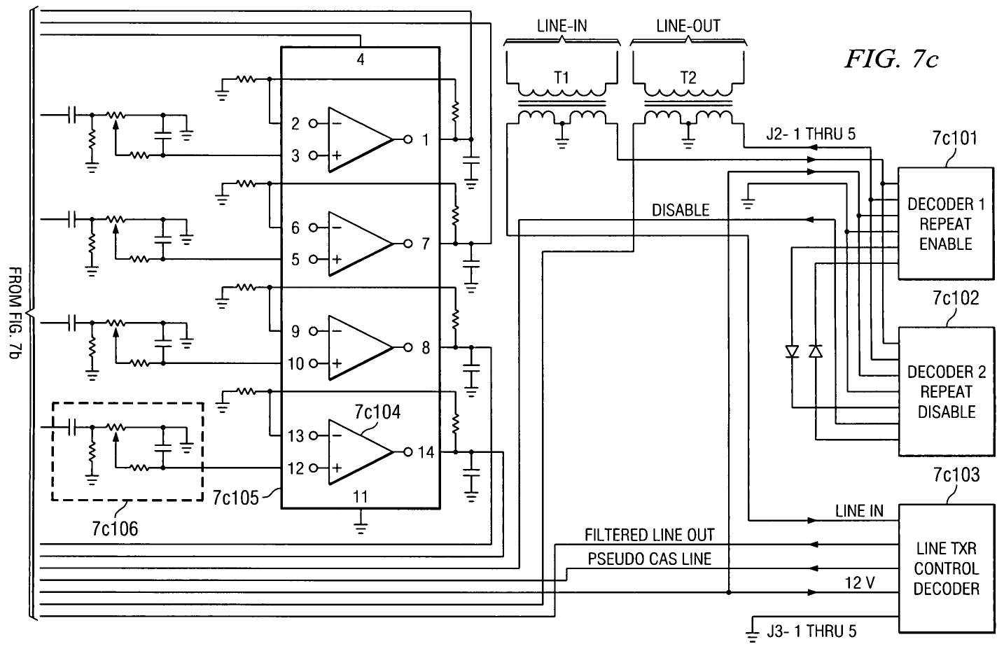

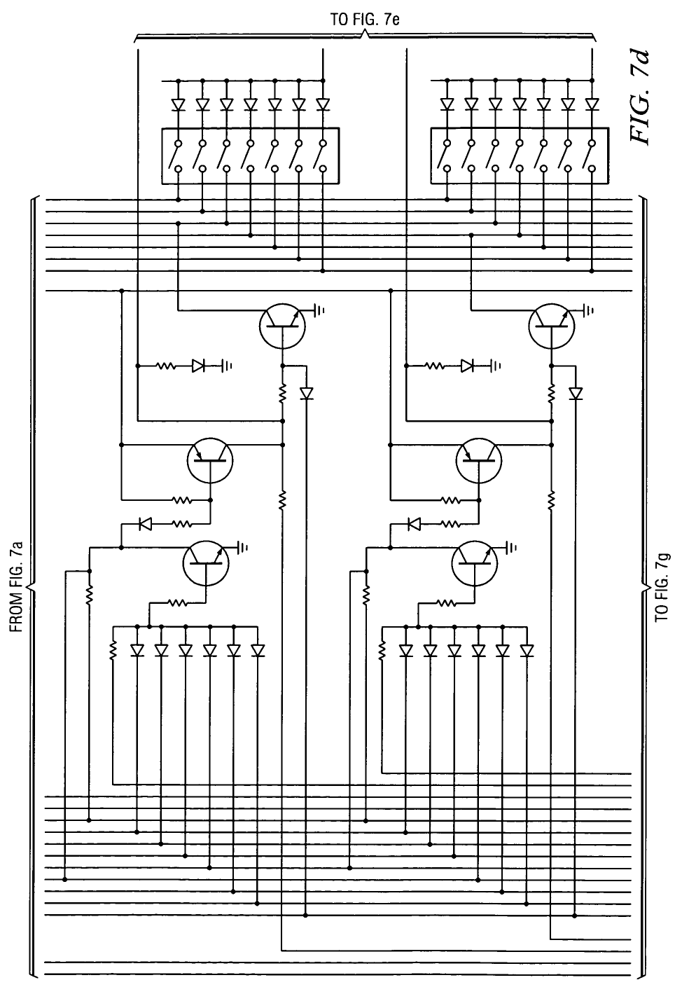

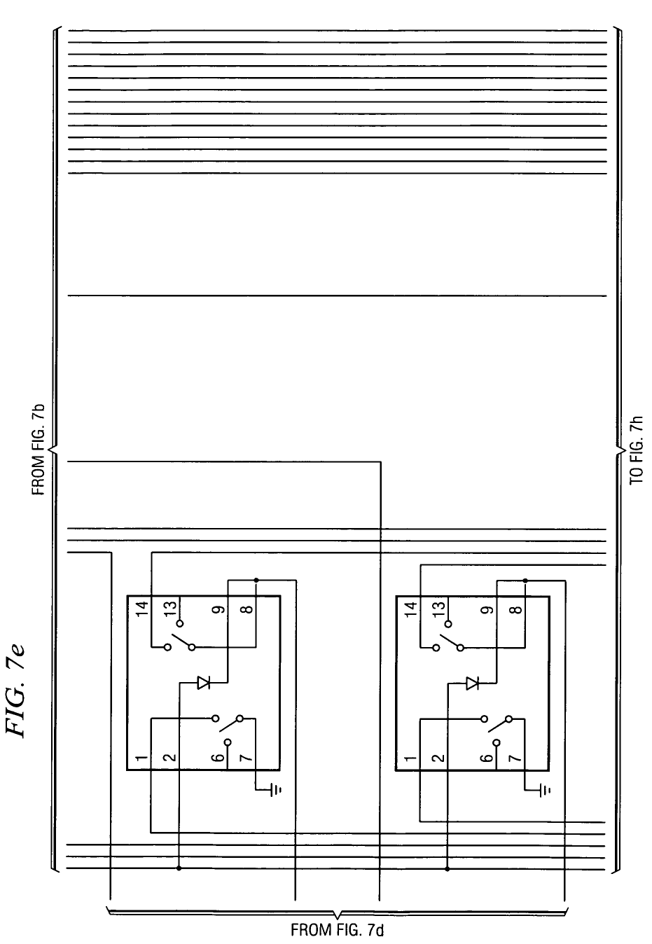

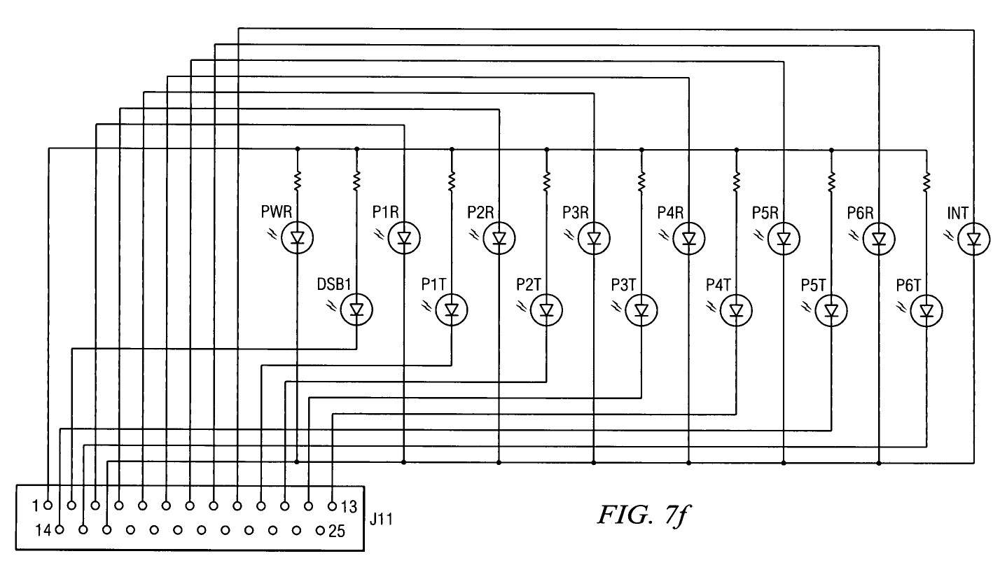

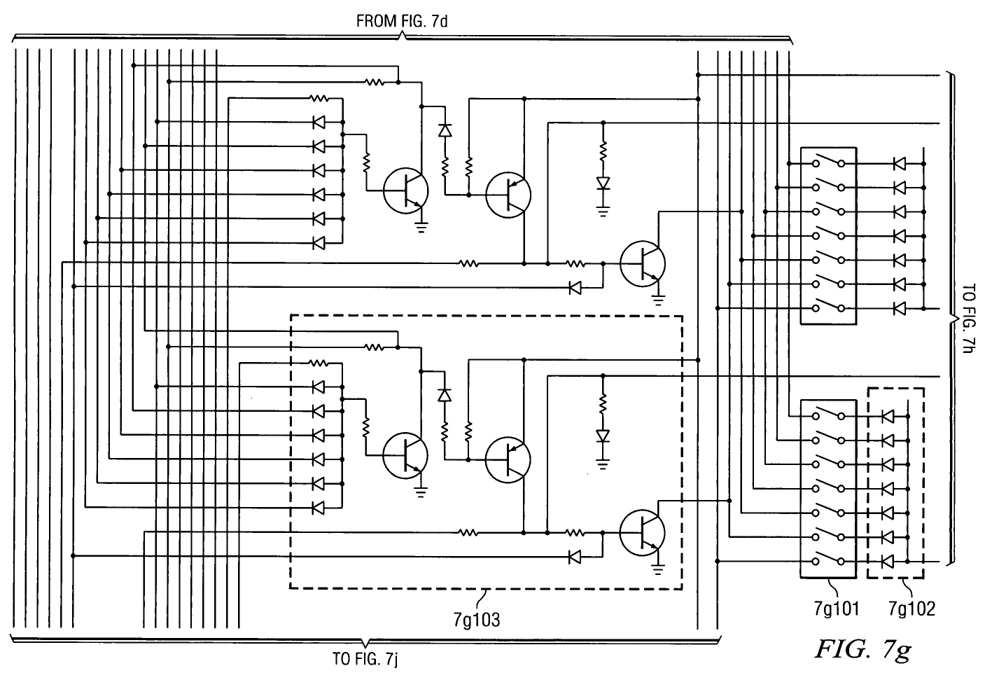

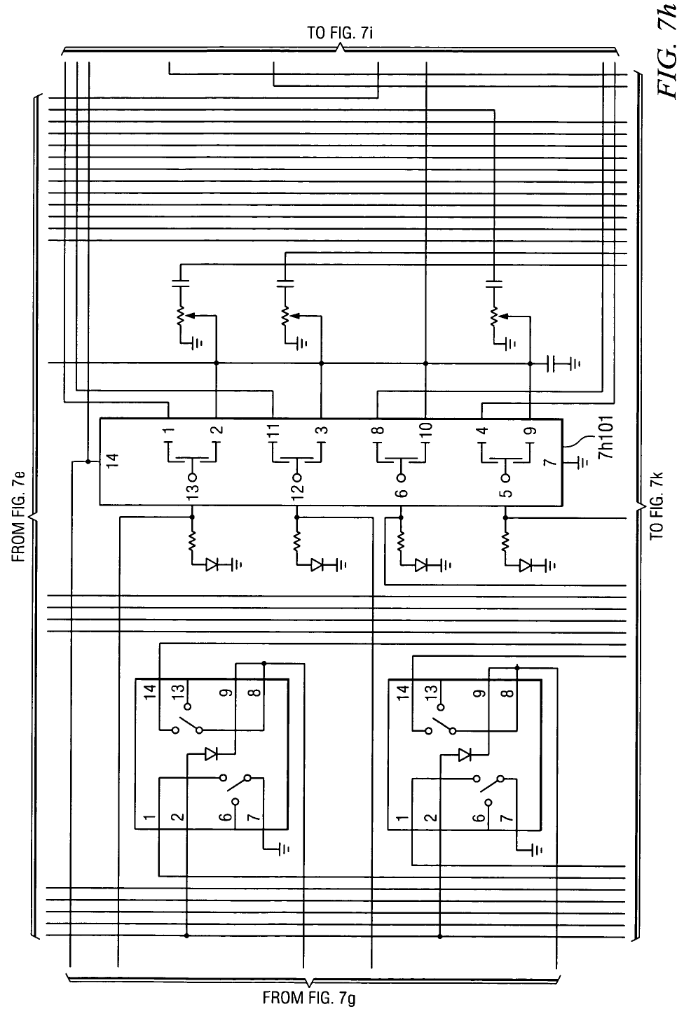

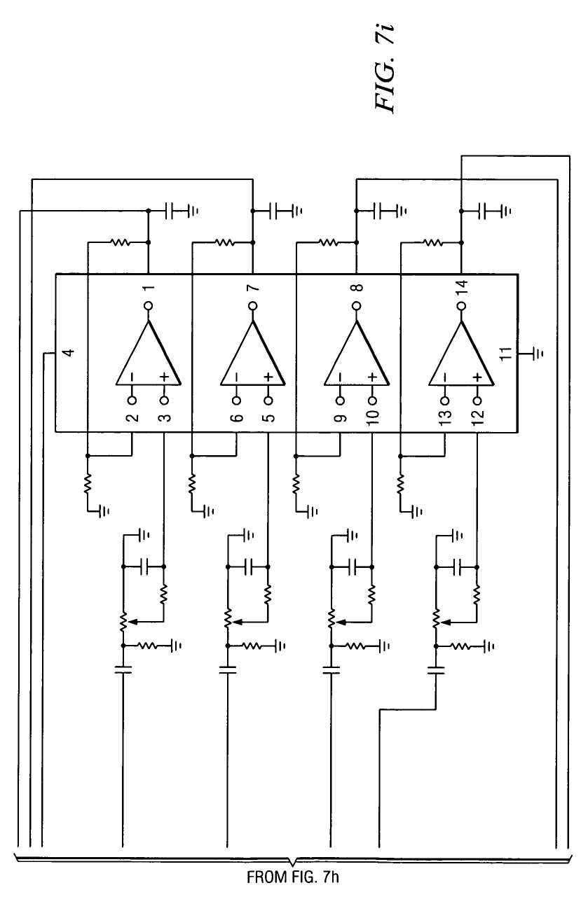

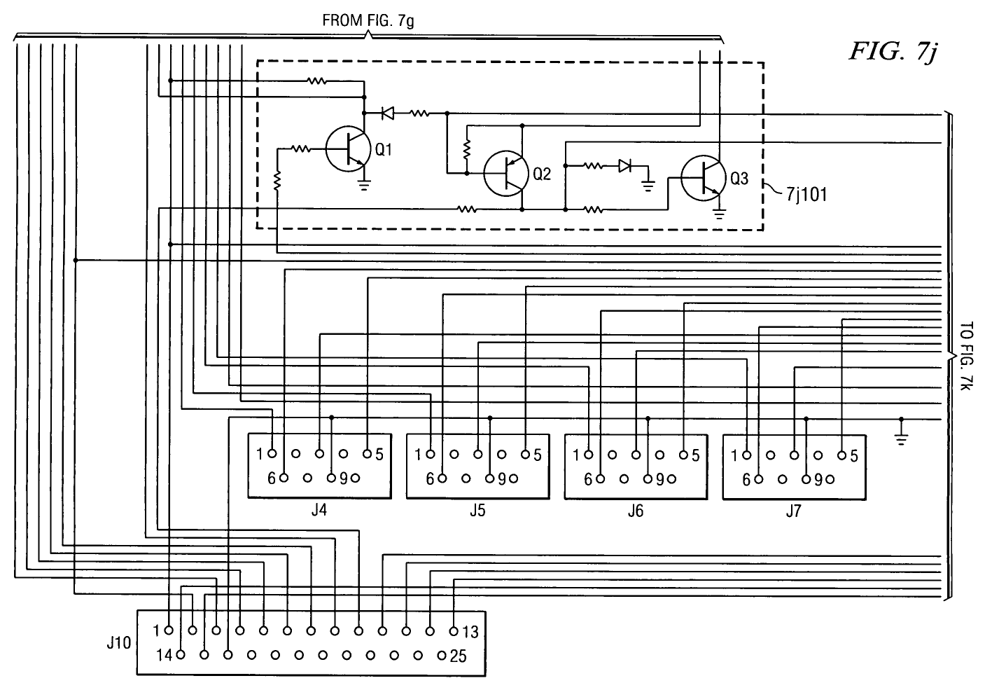

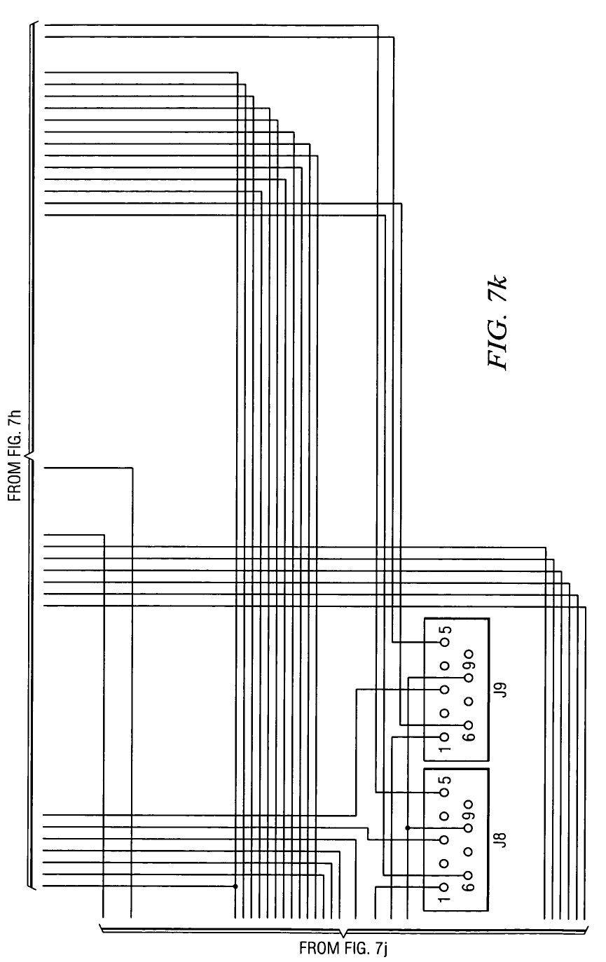

Turning next to FIGS. 7a to 7k that can be viewed and read collectively as a single drawing, illustrated is a circuit schematic of a preferred embodiment interoperability radio controller of the present invention. This circuit schematic represents an implementation of a controller that corresponds substantially to the block diagram illustrated and described above with reference to FIG. 6 (with certain differences that will be highlighted in the following discussion). A microprocessor is not included in the illustration in FIGS. 7a to 7k to perform the supervisory and control functions. These supervisory and control functions are implemented on this drawing substantially with discreet circuit components.

In the embodiment illustrated in FIGS. 7j and 7k six interoperability radio ports are configured to transmit and receive half-duplex and full-duplex signals to and from field operators. These ports are configured with connectors J4, . . . , J9, which provide means to couple the interoperability radio controller 600 to six local radio transceivers such as transceivers 506, 507, 508, and 509 on FIG. 5. The six interoperability radio ports in this exemplary arrangement are functionally similar to the interoperability radio ports 601, 602, and 603 described hereinabove with reference to FIG. 6. The six local radio transceivers are employed to provide communication over mutual-aid channels on six selected government radio services as previously described. Each connector is configured with nine pins wherein pin 1 carries the receiver sensing signal (carrier detect), pin 3 carries the transmitter control signal (“push to talk”), pin 5 carries the received audio signal, pin 6 carries the transmitted audio signal, and pin 8 is circuit ground. Pins 1, 3, 5, and 6 correspond, respectively, to lines 601a, 601c, 601b, and 601d that were described hereinabove with reference to FIG. 6.

The dispatcher transmit and receive lines 606a and 606b on FIG. 6, are shown on FIG. 7c as LINE-OUT and LINE-IN, and are coupled to transformers T2 and T1, respectively, to provide metallic isolation and circuit impedance matching for the four-wire telephony circuit (such as line 503 of FIG. 5). Transformers T2 and T1 are coupled to blocks 7c101 and 7c102, each configured with DTMF decoders that are coupled together in a flip-flop arrangement. Reception of a designated DTMF sequence enables interoperability radio communication, and a second reception of a designated DTMF sequence disables it. The line control decoder block 611 and the control tone filtering block 612 illustrated on FIG. 6 are combined and represented on FIG. 7c as LINE TXR CONTROL DECODER block 7c103. This block detects and filters a single-frequency signal superimposed on the audio signal from the dispatcher LINE-IN port illustrated on FIG. 7c.

The device isolator blocks illustrated on FIG. 6, for example block 614 controlled by line 615 and driving line 601c, are implemented in the circuit illustrated on FIGS. 7B, 7E, and 7H with six relays, one of which is the relay 7b101 on FIG. 7b. An exemplary relay is a reed relay such as part number W171DIP-27 from Magnecraft. These relays provide the dry contact closures for the transmit control lines and also provide signals to illuminate LEDs on the display panel illustrated on FIG. 7f. A transmit control line is coupled to lead 1 of relay 7b101 and an LED signal is furnished on lead 14. The relay coil in each relay is coupled to leads 2 and 9. A diode such as 7b102 as illustrated on FIG. 7b is coupled across the relay coil to prevent high voltages that may cause arcing when the relay coil drive circuit is opened.

A received audio signal carried on pin 5 of a interoperability radio port, for example, a port coupled to connector J7 on FIG. 7j, is coupled to a receive buffer amplifier such as 7c104 illustrated on FIG. 7c, which corresponds to receive buffer amplifier 609 illustrated on FIG. 6. The received audio signal is adjustably attenuated and filtered by an attenuation and filtering network such as network 7c106 illustrated on FIG. 7c. Additional attenuation and filtering networks coupled to receive buffer amplifiers are illustrated on FIG. 7i.

The receive buffer amplifiers are coupled to a communication switching block. Communication switching block 607 illustrated on FIG. 6 is implemented on FIG. 7h with bilateral switch 7h101. This switch is implemented with an integrated CMOS device that provides four independently controlled bilateral semiconductor switches. Such a device was procured from Texas Instruments, Inc., with part number 74LV4066AD. The four control terminals for this set of integrated switches are on leads 5, 6, 12, and 13, and controlled circuit closures are provided on leads 4 and 9, 8 and 10, 3 and 11, and 2 and 1, respectively. Lead 7 is coupled to circuit ground and 5-volt dc bias for these switches is provided on lead 14. A second bilateral switching device 7b103 illustrated on FIG. 7b provides four additional controlled circuit closures for the communication switching block corresponding to the communication switching block 607 illustrated on FIG. 6. As previously described, the communication switching block allows a received audio signal from any one of the interoperability radio ports (six interoperability radio ports in the embodiment illustrated in FIG. 7, three interoperability radio ports in the embodiment illustrated in FIG. 6), or the control ports (radio control port 605, local control port 604, or receive line 606b) to be transmitted to selected ones or all of the other ports.

Signals carried on the output circuits from the communications switching blocks (corresponding to 607 on FIG. 6) are further adjustably attenuated and filtered by networks such as network 7b104 illustrated on FIG. 7b, and are coupled to pin 6 of the interoperability radio ports (corresponding to line 601d on FIG. 6) or to transmit line 606a (in the case of signals to be transmitted to dispatch station 505), carrying a transmitted audio signal.

Transistor-resistor-diode network 7j101 (on FIG. 7j) including transistors Q1, Q2, and Q3 controls the priority of the dispatcher using the four-wire telephony port coupled to LINE-IN and LINE-OUT shown on FIG. 7c. A detected receive signal on the dispatcher's port is coupled to the base of transistor Q1, enabling Q1 to conduct. This process disables all other ports, asserting the dispatcher's priority. Transistor Q2 also responds by illuminating the LN_T LED on the indicator and status panel, indicating presence of the received signal on the dispatcher's port. Transistor Q3 then energizes the transmit control relay for the dispatchers radio port, enabling the dispatcher to respond and illuminating the associated LED on the indicator and status panel.

Transistor-resistor-diode networks such as 7g103 illustrated on FIG. 7g for the six interoperability radio ports are similar to the transistor-resistor-diode network 7j101 and are shown on FIGS. 7a, 7d, and 7g. These transistor-resistor-diode networks function in a manner similar to the transistor-resistor-diode network 7j101 in that a detected received signal disables other interoperability radio ports; however, the dispatcher's port is not disabled by these networks. In this manner the priority of the dispatcher's communications is preserved.

FIG. 7f illustrates the circuit in the present example for an indicator and status panel configured in this embodiment with LEDs to indicate the status of the interoperability radio controller. LEDs indicate the presence of a received signal such as LED P1R indicating the status of a received signal on interoperability radio port 1. Other LEDs indicate the presence of a transmitted signal such as LED P1T indicating the status of a transmitted signal on interoperability radio port 1. The LED PWR indicates that power is being supplied to the controller, and LED DSB1 indicates that the controller has been disabled. LED LN_T indicates the dispatcher is transmitting.

Operation of the interoperability radio controller is disabled by decoding a particular DTMF tone set by the DECODER 2 REPEAT DISABLE block, 7c102 on FIG. 7c. Controller operation can be reenabled by decoding a particular DTMF tone set by the DECODER 2 REPEAT ENABLE block, 7c1021 on FIG. 7c.

Power for the interoperability radio controller is provided at the 12 VOLTS INPUT connection indicated on FIG. 7a. The device U101 is a three-terminal linear regulator that provides a 5-volt regulated source on lead 7A101, thereby providing bias power for the transistor-resistor-diode networks such as 7j101 on FIG. 7j, the bi-directional switches such as 7b103 on FIG. 7b, and the buffer amplifiers such as 7c105 on FIG. 7c.

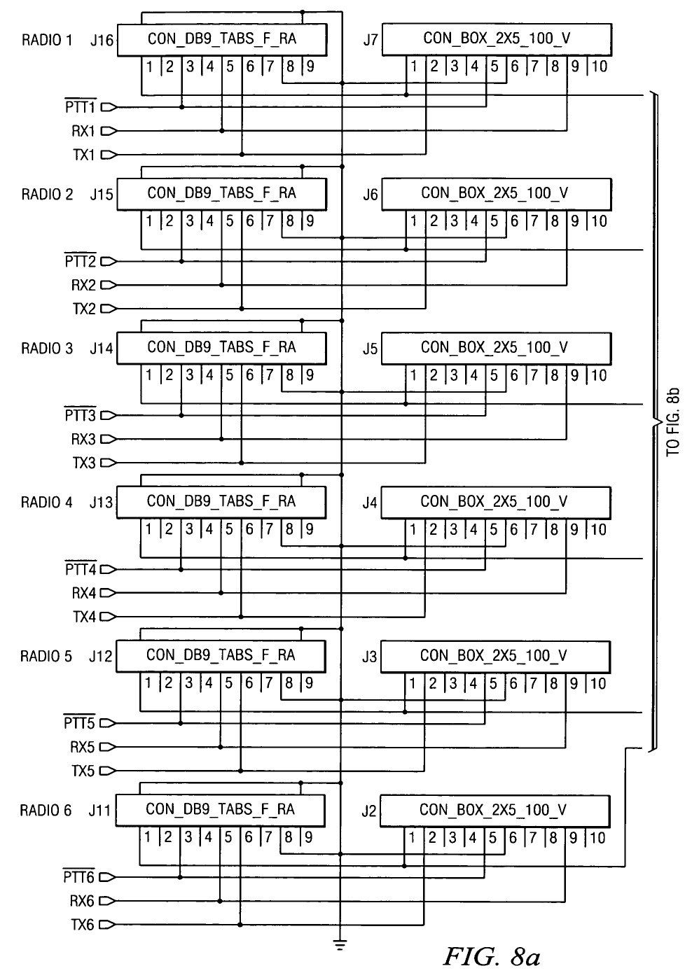

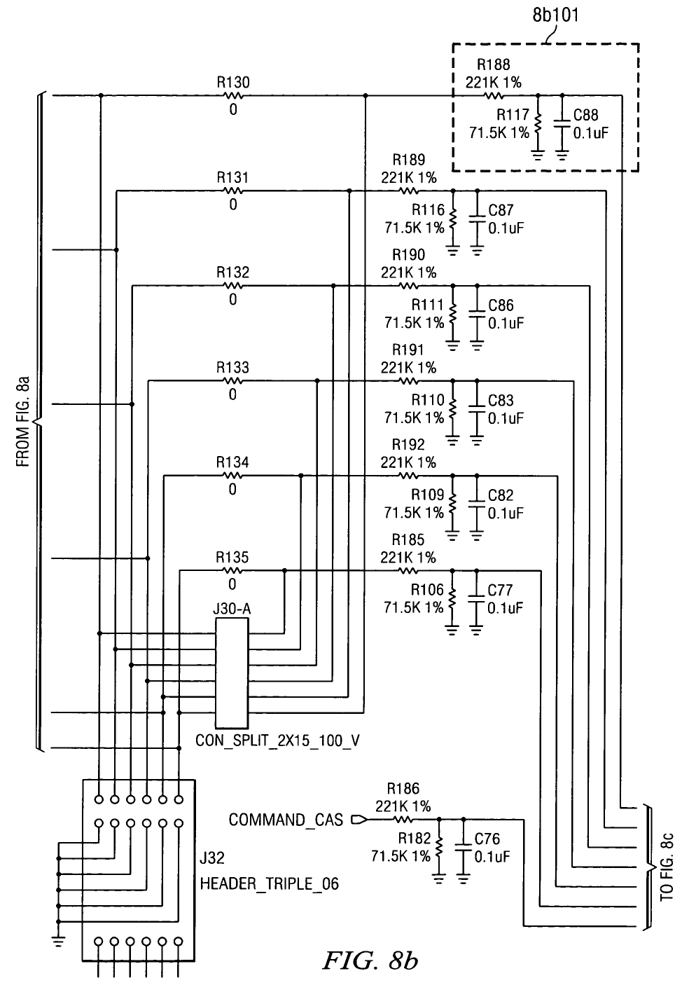

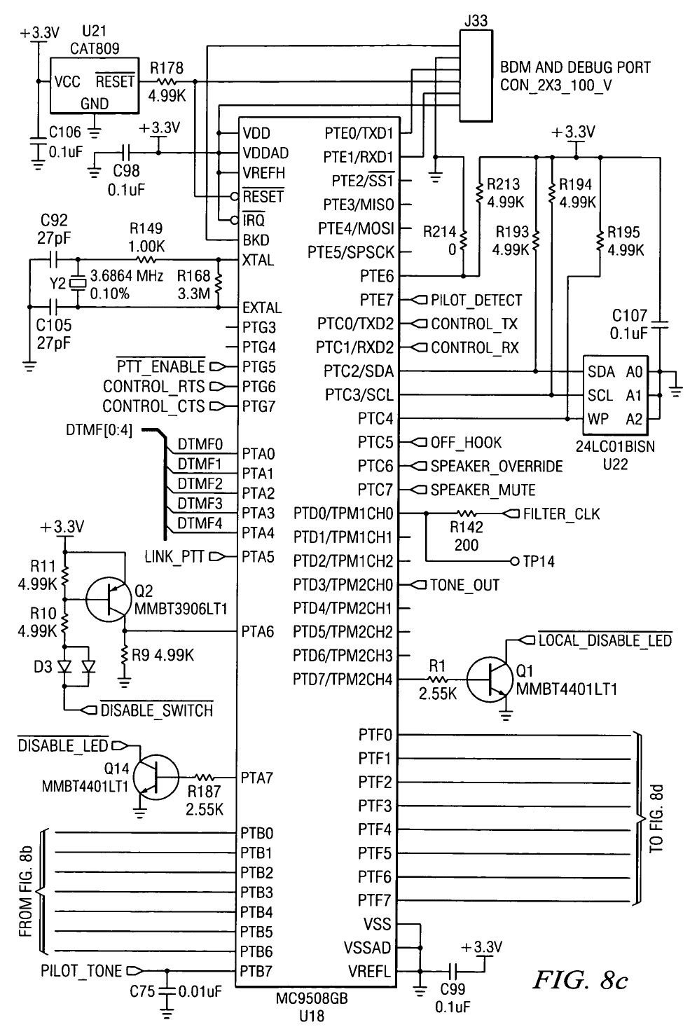

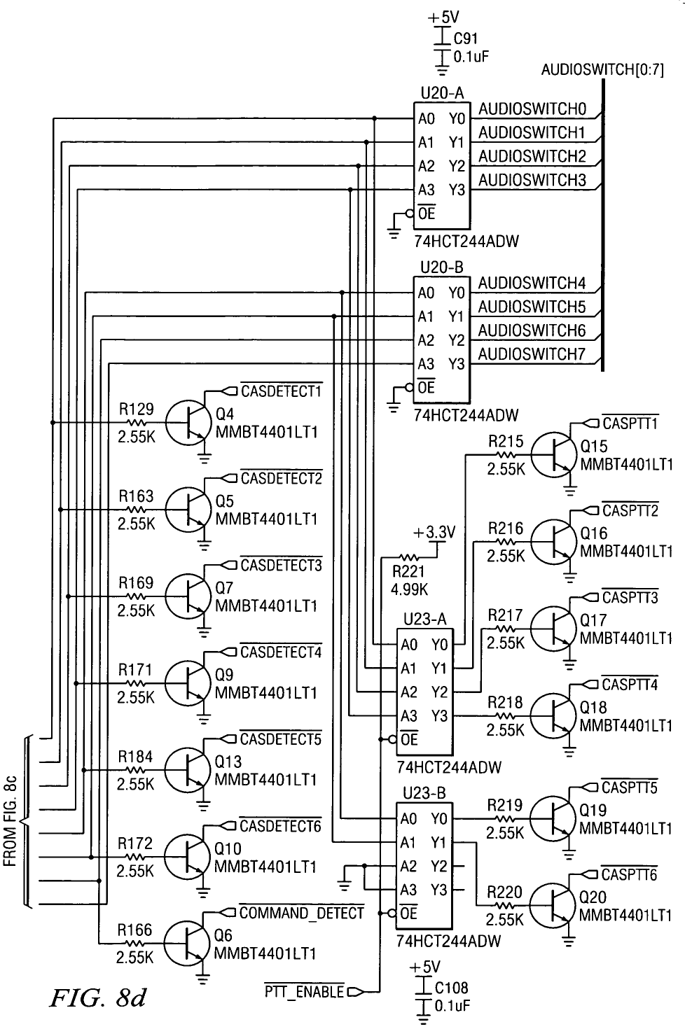

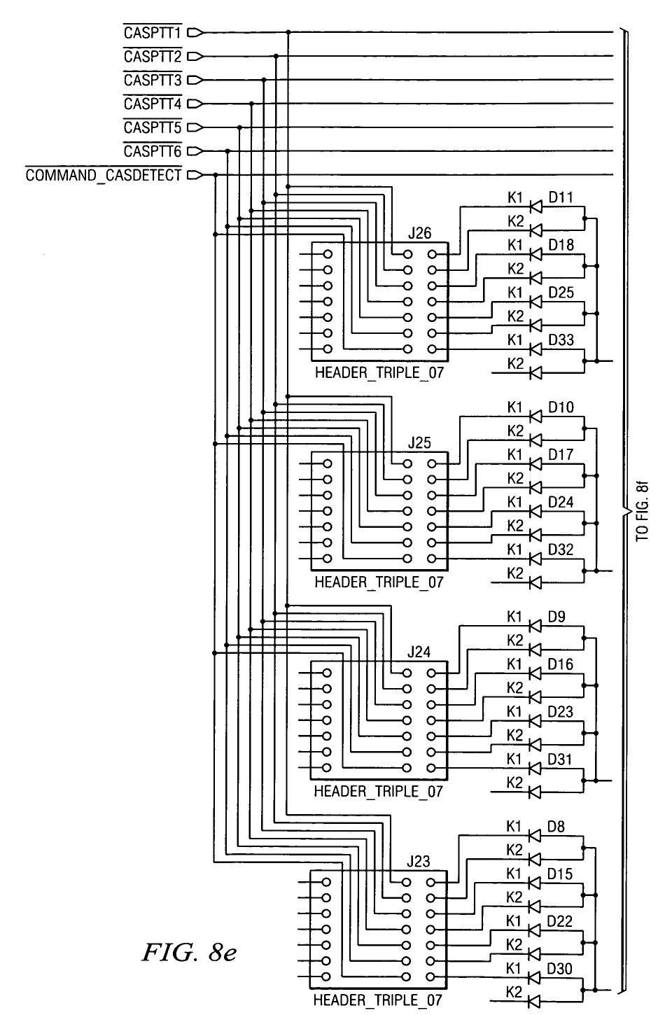

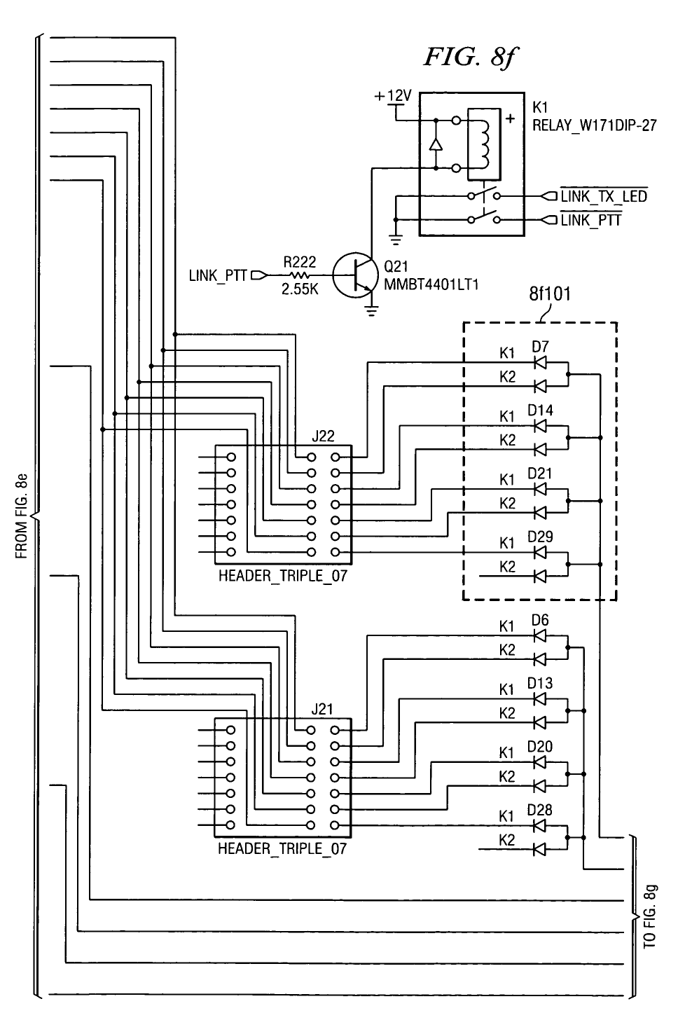

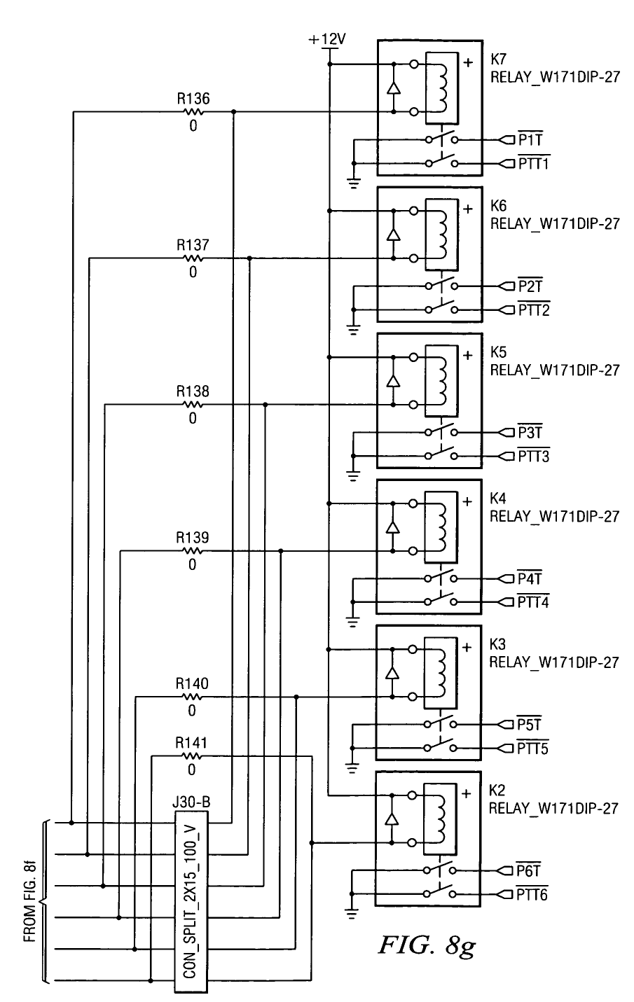

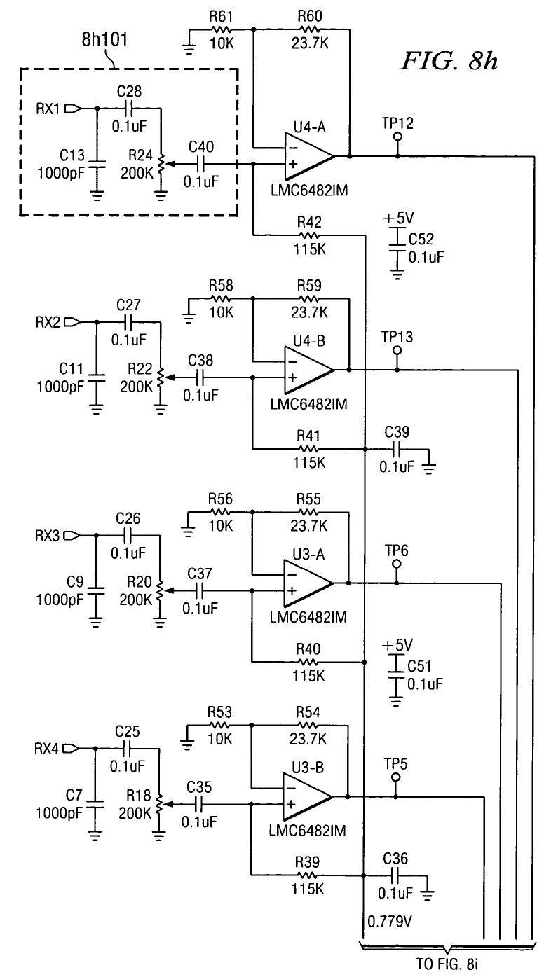

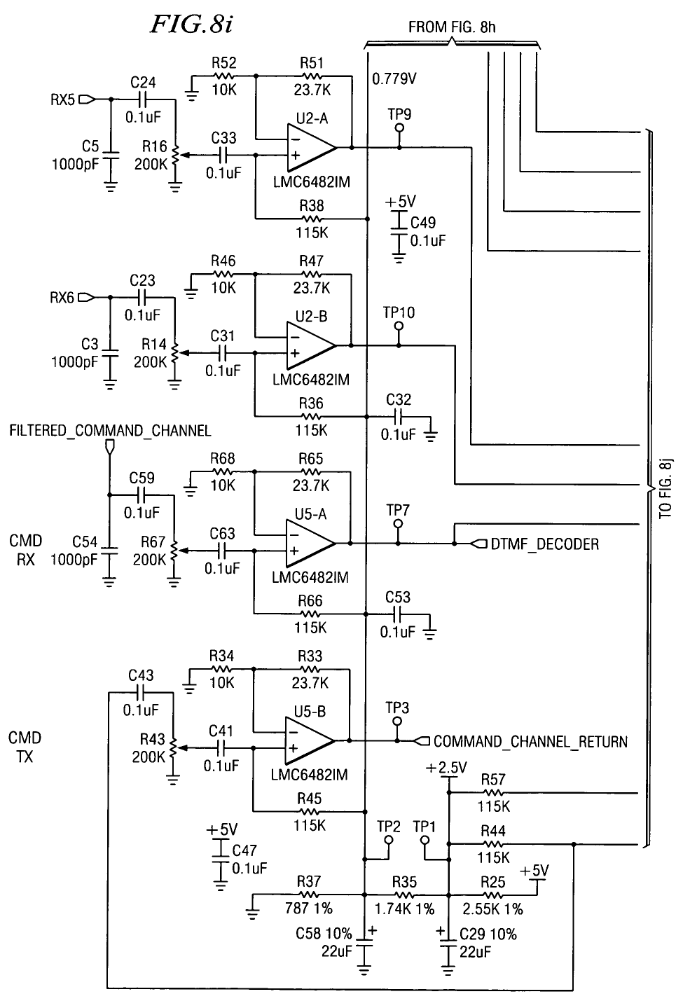

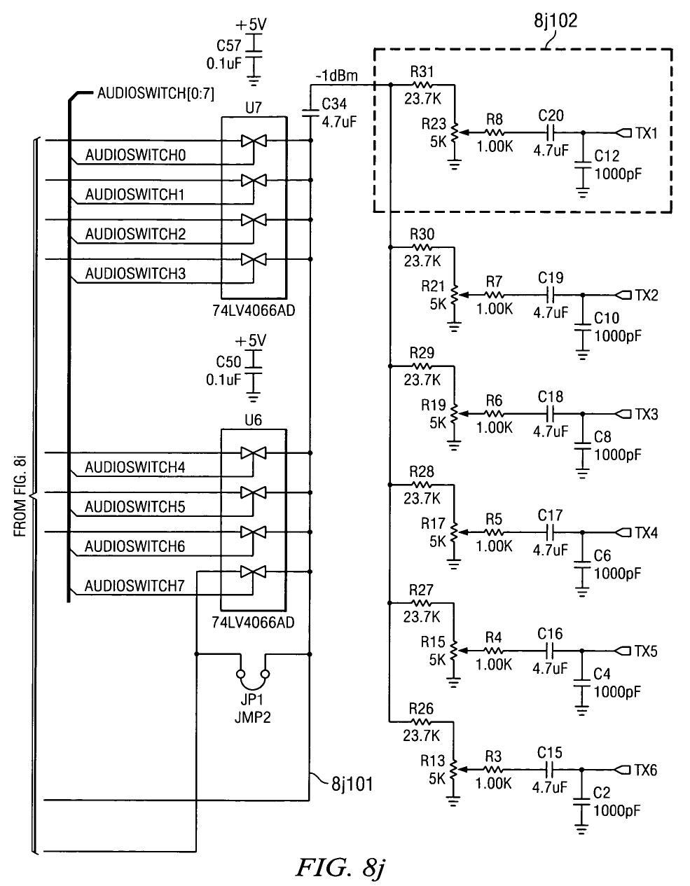

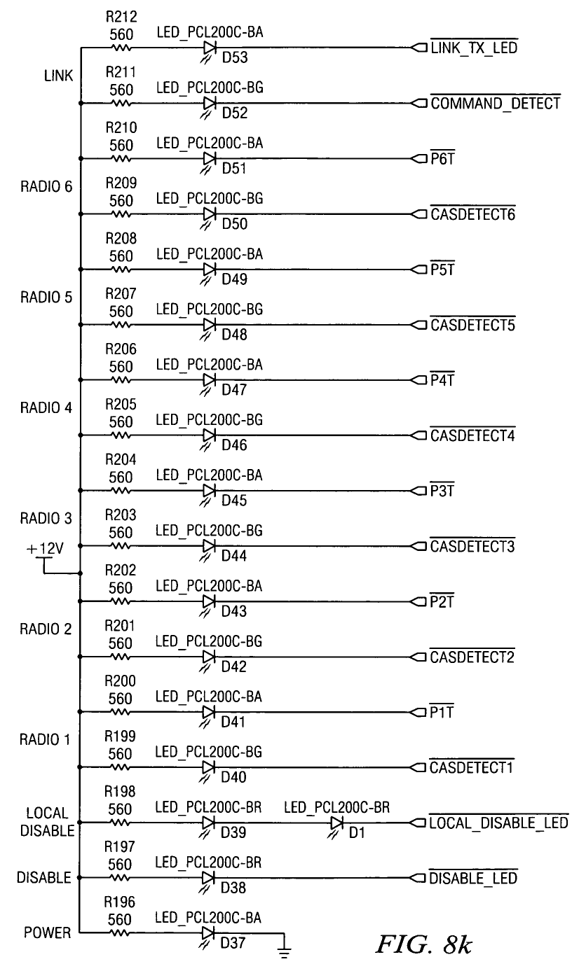

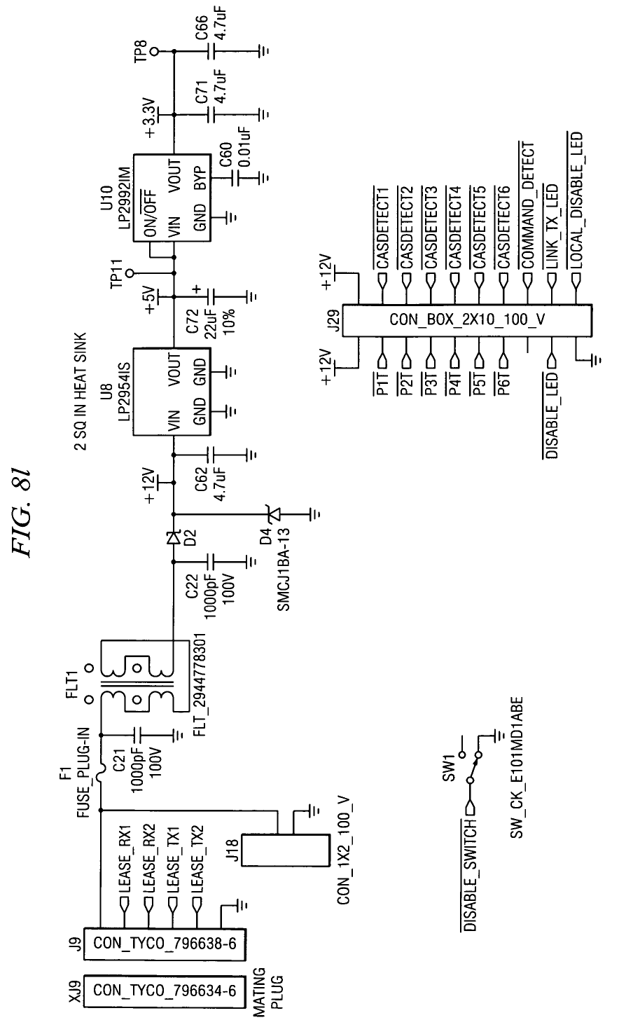

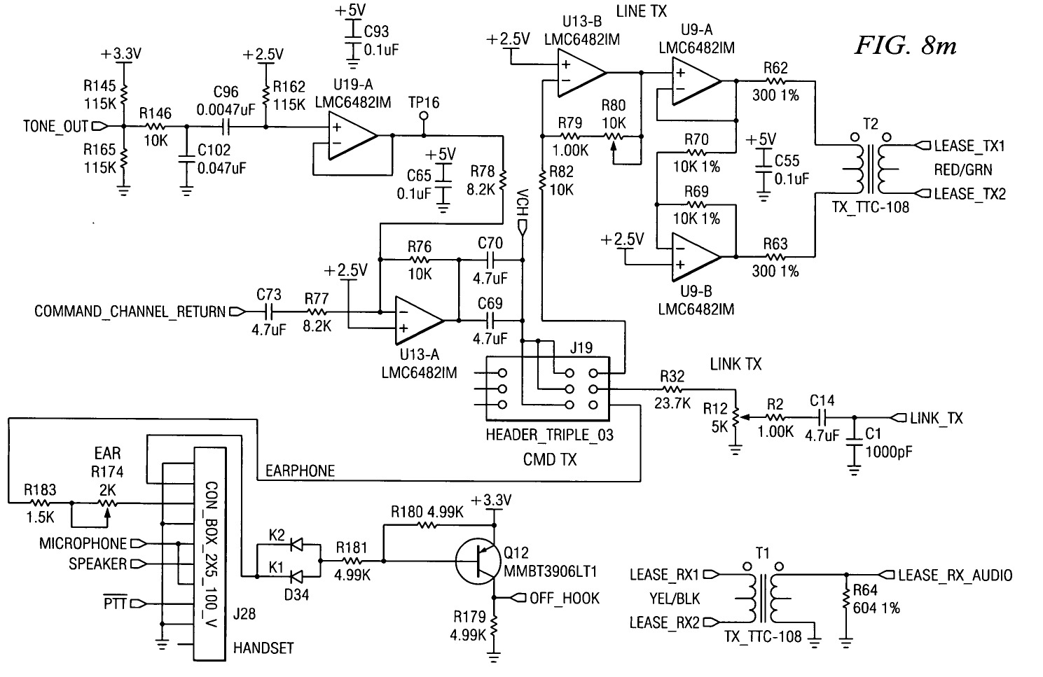

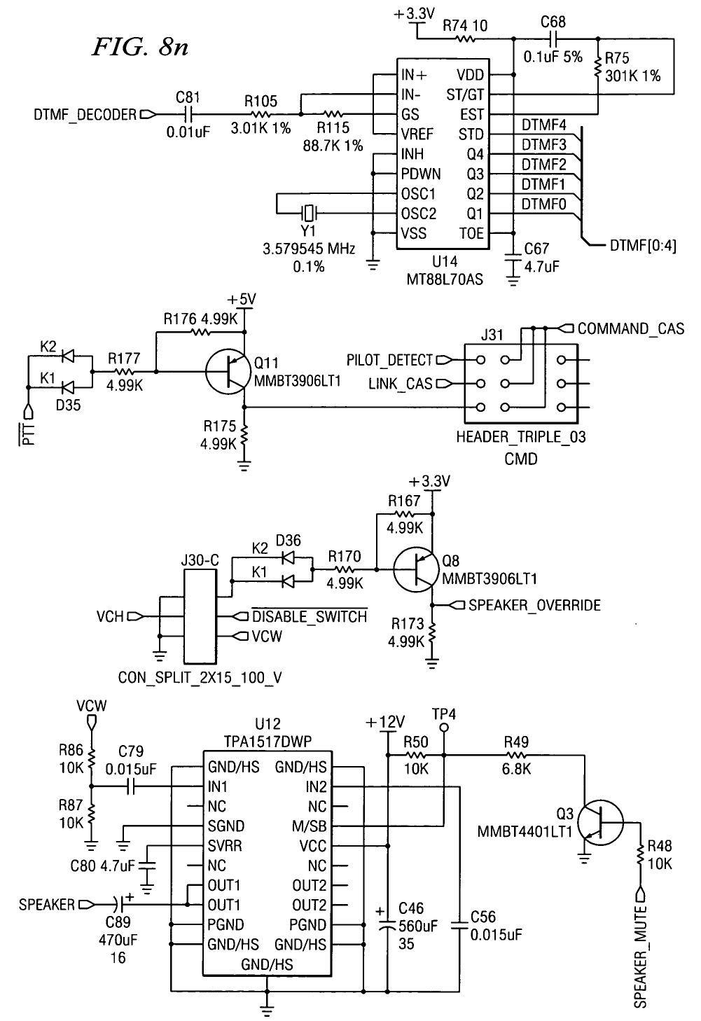

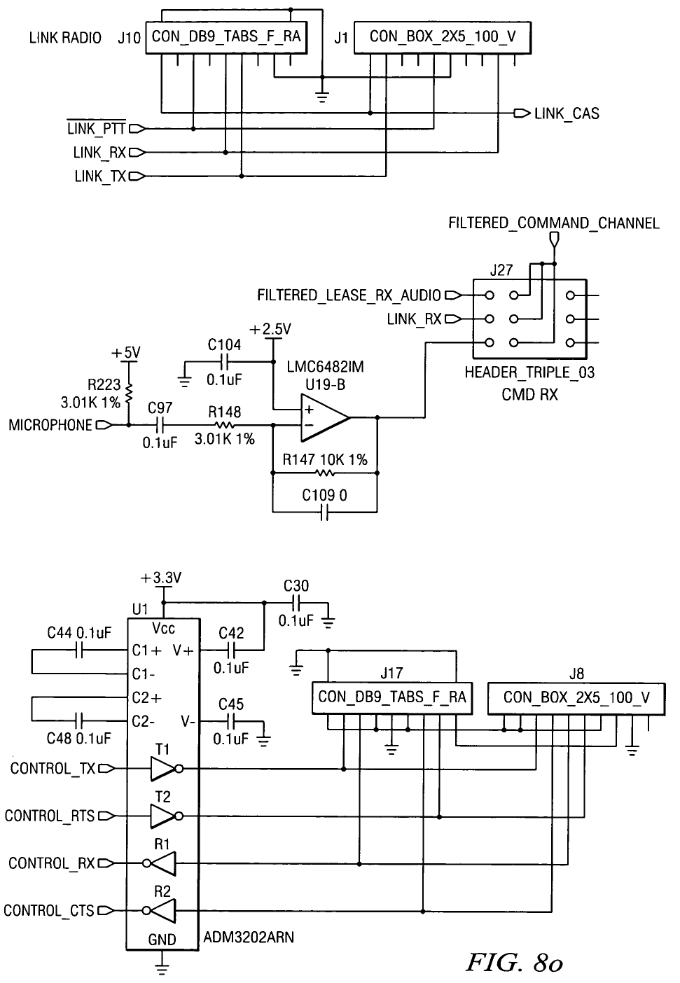

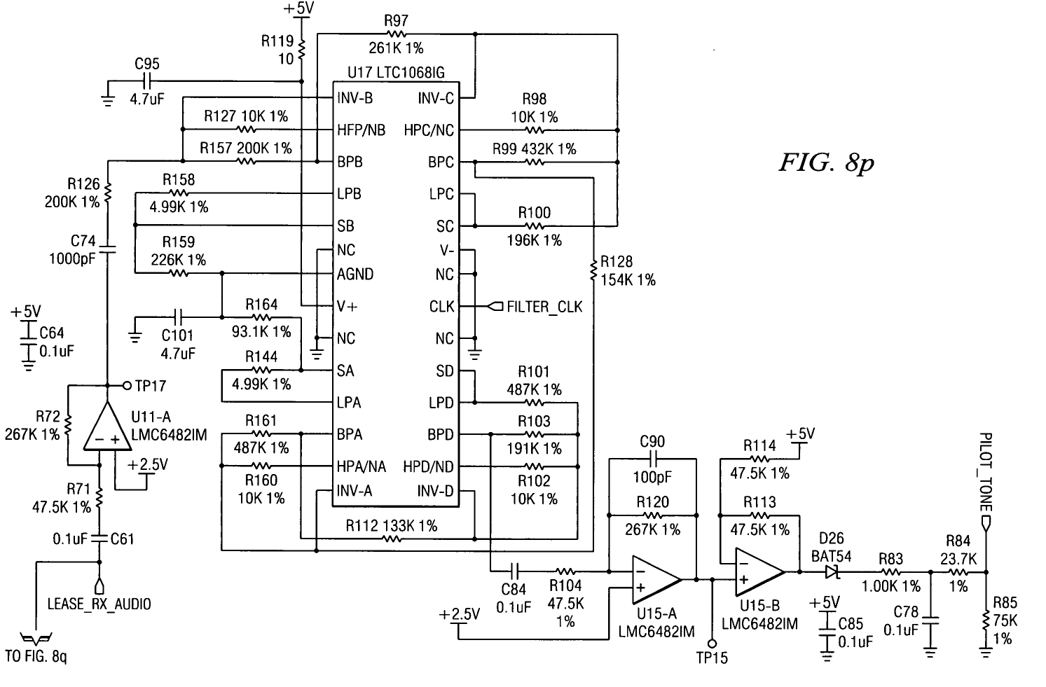

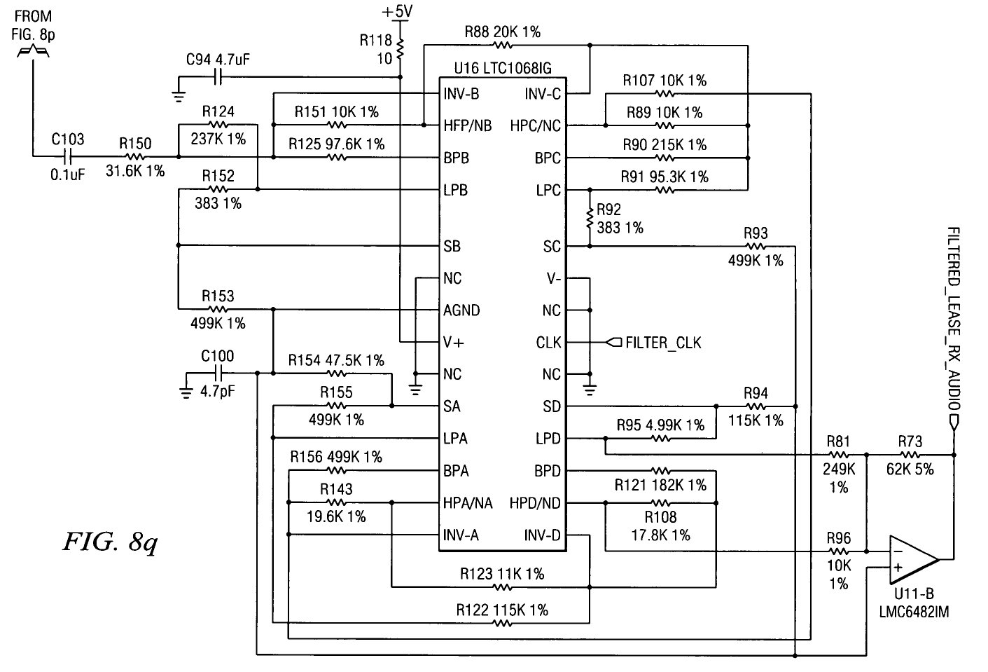

Turning next to FIGS. 8a to 8q, which can be viewed and read collectively as a single drawing, a functional circuit schematic is illustrated of another embodiment of an interoperability radio controller of the present invention configured to enable communication among six interoperability radio ports. Ports are included in the design for a dispatcher operating on a four-wire telephony circuit or a linked radio transceiver. This interoperable radio controller uses a microprocessor for supervision and control, and the controller is powered from a 12-volt, dc power source. The microprocessor used in the present example is a Motorola MC9S08 GB, but other microprocessors can be readily configured to operate with the present invention. Specific component values and specific device part numbers for the controller are indicated on FIGS. 8a to 8q.

The interoperability radio ports RADIO 1, . . . , RADIO 6 on FIG. 8a are configured with connectors J2, . . . , J7 and J11, . . . , J16 to couple radio transceivers to the interoperability radio controller that are operable on selected frequency bands that may be assigned to government services. Connectors J2, . . . ,J7 are paralleled in pairs with connectors J11, . . . , J16 of a different connector style to provide flexibility for connecting radio transceivers procured from different vendors. Of course, further flexibility in connecting different models of radio transceivers can be provided by using connector adaptors that may be configured with various cabling arrangements.

In operation, upon detecting a signal indicating an incoming radio transmission with sufficient amplitude for intelligible communication, a radio transceiver applies a voltage to a receiver sensing line indicating the received communication, for example a voltage applied to pin 1 in connector J16. This signal is coupled to the microprocessor U18 through a noise-attenuating low-pass filter, such as filter 8b101 illustrated on FIG. 8b. The jumper header J32 on FIG. 8b can be used to selectively disable received signals from the radio transceivers coupled to the radio ports RADIO 1, . . . , RADIO 6. Upon reception of this signal, the microprocessor inhibits transmission of other communications with the exception of communications from the dispatcher that are accorded the highest priority. The received audio signal from the receiving radio transceiver is coupled from pin 5 of connector J16 to an adjustable attenuation and filtering network for conditioning, such as network 8h101 on FIG. 8h, and from there to an input buffer amplifier, for example, an amplifier such as amplifier U4-A. The output from the input buffer amplifier is coupled to bilateral switch U7 on FIG. 8j (or to bilateral switch U6 for certain other input ports). The bilateral switches selectively couple the conditioned received audio signal to a common bus 8j101 that is coupled to another adjustable attenuation and filtering network, for example network 8j102, illustrated on FIG. 8j. The output of the another adjustable attenuation and filtering network is coupled to the transmit audio signal pin of one or more radio transceiver connectors such as pin 6 of connector J15, for instance. In response, one or more radio transceivers is enabled to transmit under the selective control of the dispatcher (operating via the system processor U18) by a contact closure coupled, for example, to pin 3 of connector J15. Reed relays such as relay K7 on FIG. 8g provide the contact closure. In this manner a signal transmitted by an operator using a government service in one radio communication community can be retransmitted and received in an orderly manner by one or more operators in another communication community, with priority controlled by a dispatcher.

The reed relays are closed by a diode and jumper arrangement such as diode network 8f101 coupled to jumper header J22 on FIG. 8f. The jumpers are coupled to transistor drivers such as transistor Q15 on FIG. 8d. The transistor drivers are enabled to conduct by signals from the microprocessor U18.

A visual indication of the operational status of the interoperable radio controller is provided on an indicator and status panel. LEDs D37, . . . , D52 on FIG. 8k are selectively illuminated to show the status of power, the disabled or enabled state of the system, and active signals carried by the transmit and receive pins of the six ports and the local link. LEDs indicating detection of received signals are driven by transistors Q4, Q5, Q6, Q7, Q9, Q10 and Q13 on FIG. 8d. These transistors are controlled to conduct by a signal from the microprocessor U18 that applies current to their bases. Transistors Q1 and Q14 on FIG. 8c drive LEDs D38 and D39 to indicate the disabled or enabled state of the system. Contacts on the transmit enabling relays K1 on FIG. 8f and K2, . . . , K7 on FIG. 8g drive the LEDs, indicating the transmitting state of the various ports.

A power amplifier, U12 on FIG. 8n, is included to provide an amplified audio signal for the dispatcher that can be coupled to a loudspeaker. Another amplifier, configured with operational amplifiers U19-A and U13-A on FIG. 8m, is coupled to the microprocessor U18 to provide distinctive audible tones to indicate acknowledgement or denial of dispatcher-initiated actions.

To accommodate maintenance activity at an interoperability radio controller site by a service technician, the switch SW1 on FIG. 81 is included to disable all operations of the interoperability radio controller. Switch SW1 enables transistor Q2 on FIG. 8c to conduct, signaling the microprocessor U18 to disable system operation.

Power is supplied to the interoperability radio controller from a 12-volt dc source through connector J9 on FIG. 81. The three-terminal regulator U8 provides voltage regulation for an internal 5-volt bus, and a second three-terminal regulator U10 provides regulation for an internal 3.3-volt bus.

Appendix A, below, provides an exemplary C-Program source listing for the MC9S08 GB microprocessor. The program is configured for either a stationary or a portable interoperability radio controller. Accordingly, conditional tests are included in the listing to modify the program execution depending on the application.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A method of radio interoperability process, comprising:
providing a plurality of radio frequency bands each including a mutual-aid channel;
identifying a plurality of governmental agencies each having a radio communication system operating within one of the radio frequency bands comprising the plurality thereof;
determining a state of emergency;
selecting at least two agencies from the plurality thereof for response to the state of emergency;
directing each selected agency to tune its radio communication system to the mutual-aid channel within the radio frequency band utilized by each selected agency's radio communication system; and
interconnecting the mutual-aid channels of all of the radio frequency bands comprising the plurality thereof for the duration of the state of emergency.

2. An interoperability radio controller system, comprising:
a plurality of radio interoperability ports, each port configured with an audio transmit line and an audio receive line, a line indicating the detection of a received signal in that radio interoperability port, and a line controlling transmission of a first coupled radio transceiver;
a dispatcher port configured with an audio transmit line and an audio receive line, a line indicating the detection of a received signal, and a line controlling transmission of a second coupled radio transceiver; and
a priority controller that, upon detection of a received signal on a first one of the radio interoperability ports, generates a disable transmission signal on each of the other ones of the plurality of radio interoperability ports.

3. The interoperability radio controller system of claim 2, wherein an audio signal received on an audio receive line of a first radio interoperability port is re-transmitted on an audio transmit line of selected ones of the other ones of the plurality of the radio interoperability ports in response to a signal from the dispatcher port.

4. The interoperability radio controller system of claim 2 wherein the priority controller disables the re-transmission of the audio signal received on an audio receive line of a first radio interoperability port, in response to a signal from the dispatcher port.

5. The interoperability radio controller system of claim 2, wherein the priority controller sends a transmission disable signal to selected ones of the radio interoperability ports in response to a signal from the dispatcher port.

6. The interoperability radio controller system of claim 3, wherein the signal from the dispatcher port is a single-frequency tone.

7. The interoperability radio controller system of claim 3, wherein the signal from the dispatcher port is a DTMF signal.

8. The interoperability radio controller system of claim 3 further comprising:
a plurality of radio transceivers, each radio transceiver coupled to a respective one of said plurality of said radio interoperability ports.

9. The interoperability radio controller system of claim 8 wherein:
a first one of said plurality of radio transceivers communicates with a first plurality of mobile radio devices using a first frequency/modulation/coding protocol; and
a second one of said plurality of radio transceivers communicates with a second plurality of mobile radio devices using a second frequency/modulation/coding protocol, different than the first protocol.

10. The interoperability radio controller system of claim 3 further comprising:
a dispatch station coupled to the dispatch port, wherein a user can generate control signals to control the priority controller.

11. A radio interoperability system comprising:
a first port configured to be connected to a first local radio transceiver supporting a first radio community using a first frequency/modulation/coding protocol;
a second port configured to be connected to a second local radio transceiver supporting a second radio community using a second frequency/modulation/coding protocol, different from the first protocol;
a third port configured to be connected to a third local radio transceiver supporting a third radio community using a third frequency/modulation/coding protocol, different from the first protocol; a dispatch port configured to be connected to a dispatch station; and
a switch configured to receive as input a communication signal from one of the first, second, third, or dispatch ports and to output the communication signal to selected ones of said first, second, and third transmit lines, said selection being in response to control signals received from said dispatch port.

12. The radio interoperability system of claim 11 further comprising:
a first radio transceiver coupled to the first port;
a second radio transceiver coupled to the second port;
a third radio transceiver coupled to the third port; and
a dispatch station coupled to the dispatch port.

13. The radio interoperability system of claim 12 wherein the first radio transceiver receives radio communications broadcast using a first frequency/modulation/coding protocol and the second radio transceiver receives radio communications broadcast using a second frequency/modulation/coding protocol, different from the first protocol.

14. The radio communication system of claim 13 wherein the first protocol differs from the second protocol because of a difference in the broadcast frequency band.

15. The radio communication system of claim 13 wherein the switch comprises a processor controlling the enabled state of the first, second, and third ports.

16. The radio communication system of claim 11 wherein the first port includes a signal receive line, a signal transmit line, a signal detection line, and a transmit control line.

17. A method of providing interoperability amongst a plurality of radio communities comprising:
receiving a first communication signal from a first local radio transceiver, which first radio transceiver supports a first radio community;
selecting at least one of a plurality of other radio transceivers to receive the first communication signal; and
transmitting the first communication signal to the selected at least one of the plurality of other radio transceivers, which at least one of the plurality of other radio transceivers supports an at least one other radio community.

18. The method of claim 17 further comprising:
receiving a dispatch communication signal from a dispatch station; and
in response to receiving the dispatch communication signal from the dispatch station, disabling the transmission of the first communication signal to the selected at least of the plurality of other local radio transceivers, and transmitting the dispatch communication signal to at least one of the radio transceivers.

19. The method of claim 18 wherein said dispatch communication signal is transmitted to the first radio transceiver and to each of the plurality of other radio transceivers.

20. The method of claim 17 further comprising converting the first communication signal to a first frequency/modulation/coding protocol using a first radio transceiver; and converting the first communication signal to a second frequency/modulation/coding protocol using a second radio transceiver.

21. The method of claim 20 wherein the first frequency/modulation/coding protocol and the second frequency/modulation/coding protocol differ only by a frequency band.

22. The method of claim 21 wherein the frequency band is selected from the group consisting of UHF, VHF, low band, 800 MHz, and 900 MHz.
